(19) United States
(12) Patent Application Publication
(10) Pub. No.: US 2016/0295492 A1
(43) Pub. Date: Oct. 6, 2016

(54) Route Optimization Method, Router, and Location Manager Entity

(71) Applicant: Huawei Technologies Co., Ltd., Shenzhen (CN)

(72) Inventors: Ning He, Shenzhen (CN); Chunshan Xiong, Beijing (CN); Jianning Liu, Beijing (CN)

(21) Appl. No.: 15/187,601

(22) Filed: Jun. 20, 2016

Related U.S. Application Data
(63) Continuation of application No. PCT/CN2013/090135, filed on Dec. 20, 2013.

(51) Int. Cl. H04W 40/02; H04W 8/04

(52) U.S. Cl. CPC H04W 40/02; H04W 8/04

(57) ABSTRACT

A route optimization method, where the method includes establishing a forwarding tunnel between a first mobile router (MR) in which a first user equipment (UE) is currently located and a second MR in which a second UE is currently located, where at least one UE of the first UE and the second UE is currently located in a visited network, and transmitting data between the first UE and the second UE over the forwarding tunnel, where the forwarding tunnel is established between MRs in visited networks such that data is transmitted over the forwarding tunnel, which may reduce route redundancy.

### CROSS-REFERENCE TO RELATED APPLICATION

This application is a continuation of International Application No. PCT/CN2013/090135, filed on Dec. 20, 2013, which is hereby incorporated by reference in its entirety.

### TECHNICAL FIELD

Embodiments of the present disclosure relate to the communications field, and in particular, to a route optimization method, a router, and a location manager entity.

### BACKGROUND

In distributed mobility management (DMM), when a user is currently in a roaming state, that is, when the user moves from a home network to a visited network, a forwarding tunnel is established between a mobile router (MR) in the home network and an MR in the visited network. Then, after passing through the MR in the visited network, a packet sent by the user needs to pass through the forwarding tunnel between the MR in the visited network and the MR in the home network, pass through the MR in the home network, and then arrive at a destination address.

All data of a user in a roaming state is still transmitted over the home network, and therefore, when the user is far away from the home network, a problem of route redundancy is caused.

### SUMMARY

Embodiments of the present disclosure provide a route optimization method, a router, and a location manager entity (LM), which can resolve a problem of route redundancy.

According to a first aspect, a route optimization method is provided, where the method includes establishing a forwarding tunnel between a first MR in which a first user equipment (UE) is currently located and a second MR in which a second UE is currently located, where at least one UE of the first UE and the second UE is currently located in a visited network, and transmitting data between the first UE and the second UE over the forwarding tunnel.

With reference to the first aspect, in a first possible implementation manner, establishing a forwarding tunnel between a first MR in which the first UE is currently located and a second MR in which the second UE is currently located includes sending, by the first MR, a first route request message to a home location manager entity (H-LM) of the second UE, where the first route request message includes an Internet Protocol (IP) address of the second UE, receiving, by the first MR, a first route response message sent by the H-LM of the second UE, where the first route response message includes an address of the second MR, and establishing, by the first MR, a forwarding tunnel between the first MR and the second MR according to the address of the second MR.

With reference to the first possible implementation manner of the first aspect, in a second possible implementation manner, before sending, by the first MR, a first route request message to an H-LM of the second UE, the method further includes receiving, by the first MR, a packet sent by the first UE, acquiring, by the first MR, the IP address of the second UE in the packet, and buffering, by the first MR, the packet, and after establishing, by the first MR, a forwarding tunnel between the first MR and the second MR according to the address of the second MR, the method further includes transmitting, by the first MR, the packet to the second MR over the forwarding tunnel.

With reference to the first possible implementation manner and the foregoing implementation manner of the first aspect, in a third possible implementation manner, when the first UE is currently located in a home network, the first route request message further includes first flag bit information, and the first flag bit information is used to indicate that the first MR is a home MR (H-MR) of the first UE.

With reference to the first possible implementation manner and the foregoing implementation manners of the first aspect, in a fourth possible implementation manner, when the second UE is currently located in a home network, the first route response message further includes second flag bit information, and the second flag bit information is used to indicate that the second MR is an H-MR of the second UE.

With reference to the first possible implementation manner and the foregoing implementation manners of the first aspect, in a fifth possible implementation manner, establishing, by the first MR, a forwarding tunnel between the first MR and the second MR according to the address of the second MR includes sending, by the first MR, a first tunnel establishment request message to the second MR, and receiving, by the first MR, a first tunnel establishment response message sent by the second MR in order to complete establishing the forwarding tunnel.

With reference to the first possible implementation manner and the foregoing implementation manners of the first aspect, in a sixth possible implementation manner, establishing, by the first MR, a forwarding tunnel between the first MR and the second MR according to the address of the second MR includes receiving, by the first MR, a second tunnel establishment request message sent by the second MR, and sending, by the first MR, a second tunnel establishment response message to the second MR in order to complete establishing the forwarding tunnel.

With reference to the first possible implementation manner and the foregoing implementation manners of the first aspect, in a seventh possible implementation manner, after establishing, by the first MR, a forwarding tunnel between the first MR and the second MR according to the address of the second MR, the method further includes binding, by the first MR, the following information: an IP address of the first UE, the IP address of the second UE, the address of the second MR, and tunnel information of the forwarding tunnel.

With reference to the seventh possible implementation manner of the first aspect, in an eighth possible implementation manner, the method further includes unbinding, by the first MR, the information when the first UE is currently located in a visited network and the first UE is not currently located within a service range of the first MR any longer, or when the second UE is currently located in a visited network and the second UE is not currently located within a service range of the second MR any longer.

With reference to the first possible implementation manner and the foregoing implementation manners of the first aspect, in a ninth possible implementation manner, the method further includes releasing, by the first MR, the forwarding tunnel when the first UE is currently located in the visited network and the first UE is not currently located within the service range of the first MR any longer, or when the second UE is currently located in the visited network and the second UE is not currently located within the service range of the second MR any longer, and when the forwarding tunnel is not shared by another UE.

With reference to the ninth possible implementation manner of the first aspect, in a tenth possible implementation manner, releasing, by the first MR, the forwarding tunnel includes sending, by the first MR, a first tunnel release request message to the second MR, and receiving, by the first MR, a first tunnel release response message sent by the second MR in order to complete releasing the forwarding tunnel.

With reference to the ninth possible implementation manner of the first aspect, in an eleventh possible implementation manner, releasing, by the first MR, the forwarding tunnel includes receiving, by the first MR, a second tunnel release request message sent by the second MR, and sending, by the first MR, a second tunnel release response message to the second MR in order to complete releasing the forwarding tunnel.

With reference to the first aspect, in an eleventh possible implementation manner, when the first UE is currently located in a visited network, establishing a forwarding tunnel between a first MR in which the first UE is currently located and a second MR in which the second UE is currently located includes sending, by a third MR, a second route request message to an H-LM of the second UE, where the second route request message includes an IP address of the second UE, receiving, by the third MR, a second route response message sent by the H-LM of the second UE, where the second route response message includes an address of the second MR, and sending, by the third MR, a first route optimization command (RO command) message to the first MR, where the first RO command message includes the address of the second MR, and the first RO command message is used by the first MR to establish the forwarding tunnel between the first MR and the second MR according to the address of the second MR, or sending, by the third MR, a second RO command message to the second MR, where the second RO command message includes an address of the first MR, and the second RO command message is used by the second MR to establish the forwarding tunnel between the first MR and the second MR according to the address of the first MR, where the third MR is an H-MR of the first UE.

According to a second aspect, a route optimization method is provided, where at least one UE in a first UE and a second UE is currently located in a visited network, and the method includes receiving, by an H-LM of the first UE, a route request message sent by a second MR in which the second UE is currently located, where the route request message includes an IP address of the first UE, and sending, by the H-LM of the first UE, a route response message to the second MR, where the route response message includes an address of a first MR in which the first UE is currently located.

With reference to the second aspect, in a first possible implementation manner, when the second UE is currently located in a home network, the route request message further includes first flag bit information, and the first flag bit information is used to indicate that the second MR is an H-MR of the second UE.

With reference to the second aspect, in a second possible implementation manner, when the first UE is currently located in a home network, the route response message further includes second flag bit information, and the second flag bit information is used to indicate that the first MR is an H-MR of the first UE.

According to a third aspect, a route optimization method is provided, where the method includes sending, by an MR in which a first UE is currently located, a route request message to an H-LM of a second UE, where the route request message includes an IP address of the first UE and flag bit information, and the flag bit information is used to indicate that the MR is an H-MR of the first UE, and receiving, by the MR, a route rejection message sent by the H-LM of the second UE.

According to a fourth aspect, a route optimization method is provided, where the method includes receiving, by an H-LM of a second UE, a route request message sent by an MR in which a first UE is currently located, where the route request message includes an IP address of the first UE and flag bit information, and the flag bit information is used to indicate that the MR is an H-MR of the first UE, and sending, by the H-LM of the second UE, a route rejection message to the MR.

According to a fifth aspect, a route optimization method is provided, where a first UE is currently located in a home network, and the method includes sending, by a first MR in which the first UE is currently located, a route request message to an H-LM of a second UE, where the route request message includes an IP address of the first UE, and receiving, by the first MR, a route response message sent by the H-LM of the second UE, where the route response message includes flag bit information, and the flag bit information is used to indicate that a second MR in which the second UE is currently located is an H-MR of the second UE.

According to a sixth aspect, a route optimization method is provided, where a first UE is currently located in a home network, and the method includes receiving, by an H-LM of a second UE, a route request message sent by a first MR in which the first UE is currently located, where the route request message includes an IP address of the first UE, and sending, by the H-LM of the second UE, a route response message to the first MR, where the route response message includes flag bit information, and the flag bit information is used to indicate that a second MR in which the second UE is currently located is an H-MR of the second UE such that the first MR terminates a route optimization process.

According to a seventh aspect, an MR is provided, where the MR is an MR in which a first UE is currently located, and the MR includes a sending unit configured to send a route request message to an H-LM of a second UE, where the route request message includes an IP address of the second UE, a first receiving unit configured to receive a route response message sent by the H-LM of the second UE, where the route response message includes an address of a second MR in which the second UE is currently located, and an establishing unit configured to establish a forwarding tunnel between the MR and the second MR according to the address of the second MR, where at least one UE of the first UE and the second UE is currently located in a visited network.

With reference to the seventh aspect, in a first possible implementation manner, the MR further includes a second receiving unit configured to receive a packet sent by the first UE, an acquiring unit configured to acquire the IP address of the second UE in the packet received by the second receiving unit, a buffering unit configured to buffer the packet received by the second receiving unit, and a transmission unit configured to transmit, to the second MR over the forwarding tunnel established by the establishing unit, the packet buffered by the buffering unit.

With reference to the seventh aspect or the foregoing implementation manner, in a second possible implementation manner, when the first UE is currently located in a home network, the route request message further includes first flag bit information, and the first flag bit information is used to indicate that the MR is an H-MR of the first UE.

With reference to the seventh aspect or the foregoing implementation manners, in a third possible implementation manner, when the second UE is currently located in a home network, the route response message further includes second flag bit information, and the second flag bit information is used to indicate that the second MR is an H-MR of the second UE.

With reference to the seventh aspect or the foregoing implementation manners, in a fourth possible implementation manner, the establishing unit includes a first sending subunit configured to send a first tunnel establishment request message to the second MR, and a first receiving subunit configured to receive a first tunnel establishment response message sent by the second MR in order to complete establishing the forwarding tunnel.

With reference to the seventh aspect or the foregoing implementation manners, in a fifth possible implementation manner, the establishing unit includes a second receiving subunit configured to receive a second tunnel establishment request message sent by the second MR, and a second sending subunit configured to send a second tunnel establishment response message to the second MR in order to complete establishing the forwarding tunnel.

With reference to the seventh aspect or the foregoing implementation manners, in a sixth possible implementation manner, the MR further includes a binding unit configured to bind the following information: an IP address of the first UE, the IP address of the second UE, the address of the second MR, and tunnel information of the forwarding tunnel.

With reference to the sixth possible implementation manner of the seventh aspect, in a seventh possible implementation manner, the MR further includes an unbinding unit configured to unbind the information when the first UE is currently located in a visited network and the first UE is not currently located within a service range of the MR any longer, or when the second UE is currently located in a visited network and the second UE is not currently located within a service range of the second MR any longer.

With reference to the seventh aspect or the foregoing implementation manners, in an eighth possible implementation manner, the MR further includes a releasing unit configured to release the forwarding tunnel when the forwarding tunnel is not shared by another UE.

With reference to the eighth possible implementation manner of the seventh aspect, in a ninth possible implementation manner, the releasing unit includes a third sending subunit configured to send a first tunnel release request message to the second MR, and a third receiving subunit configured to receive a first tunnel release response message sent by the second MR in order to complete releasing the forwarding tunnel.

With reference to the eighth possible implementation manner of the seventh aspect, in a tenth possible implementation manner, the releasing unit includes a fourth receiving subunit configured to receive a second tunnel release request message sent by the second MR, and a fourth sending subunit configured to send a second tunnel release response message to the second MR in order to complete releasing the forwarding tunnel.

According to an eighth aspect, an MR is provided, where the MR is an H-MR of a first UE, and includes a first sending unit configured to send a route request message to an H-LM of a second UE, where the route request message includes an IP address of the second UE, a receiving unit configured to receive a route response message sent by the H-LM of the second UE, where the route response message includes an address of a second MR in which the second UE is currently located, and a second sending unit configured to send a first RO command message to a first MR in which the first UE is currently located, where the first RO command message includes the address of the second MR, and the first RO command message is used by the first MR to establish a forwarding tunnel between the first MR and the second MR according to the address of the second MR, or configured to send a second RO command message to the second MR, where the second RO command message includes an address of the first MR, and the second RO command message is used by the second MR to establish a forwarding tunnel between the first MR and the second MR according to the address of the first MR, where the first UE is currently located in a visited network.

According to a ninth aspect, an LM is provided, where the LM is an H-LM of a first UE, and includes a receiving unit configured to receive a route request message sent by a second MR in which a second UE is currently located, where the route request message includes an IP address of the first UE, and a sending unit configured to send a route response message to the second MR, where the route response message includes an address of a first MR in which the first UE is currently located, where at least one UE of the first UE and the second UE is currently located in a visited network.

With reference to the ninth aspect, in a first possible implementation manner, when the second UE is currently located in a home network, the route request message further includes first flag bit information, and the first flag bit information is used to indicate that the second MR is an H-MR of the second UE.

With reference to the ninth aspect, in a second possible implementation manner, when the first UE is currently located in a home network, the route response message further includes second flag bit information, and the second flag bit information is used to indicate that the first MR is an H-MR of the first UE.

According to a tenth aspect, an MR is provided, where the MR is an MR in which a first UE is currently located, and includes a sending unit configured to send a route request message to an H-LM of a second UE, where the route request message includes an IP address of the first UE and flag bit information, and the flag bit information is used to indicate that the MR is an H-MR of the first UE, and a receiving unit configured to receive a route rejection message sent by the H-LM of the second UE.

According to an eleventh aspect, an LM is provided, where the LM is an H-LM of second UE, and includes a receiving unit configured to receive a route request message sent by an MR in which a first UE is currently located, where the route request message includes an IP address of the first UE and flag bit information, and the flag bit information is used to indicate that the MR is an H-MR of the first UE, and a sending unit configured to send a route rejection message to the MR.

According to a twelfth aspect, an MR is provided, where the MR is an MR in which a first UE is currently located, and includes a sending unit configured to send a route request message to an H-LM of a second UE, where the route request message includes an IP address of the first UE, and a receiving unit configured to receive a route response message sent by the H-LM of the second UE, where the route response message includes flag bit information, and the flag bit information is used to indicate that a second MR in which the second UE is currently located is an H-MR of the second UE, where the first UE is currently located in a home network.

According to a thirteenth aspect, an LM is provided, where the LM is an H-LM of second UE, and includes a receiving unit configured to receive a route request message sent by a first MR in which a first UE is currently located, where the route request message includes an IP address of the first UE, and a sending unit configured to send a route response message to the first MR, where the route response message includes flag bit information, and the flag bit information is used to indicate that a second MR in which the second UE is currently located is an H-MR of the second UE such that the first MR terminates a route optimization process, where the first UE is currently located in a home network.

According to the embodiments of the present disclosure, a forwarding tunnel is established between MRs in visited networks such that data is transmitted over the forwarding tunnel, which can reduce route redundancy.

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show merely some embodiments of the present disclosure, and a person of ordinary skill in the art may still derive other drawings from these accompanying drawings without creative efforts.

FIG. 1 is a schematic diagram of a mobility management architecture according to an embodiment of the present disclosure;

FIG. 2 is a flowchart of a route optimization method according to an embodiment of the present disclosure;

FIG. 3 is a flowchart of a route optimization method according to another embodiment of the present disclosure;

FIG. 4 is a flowchart of a route optimization method according to another embodiment of the present disclosure;

FIG. 5 is a flowchart of a route optimization method according to another embodiment of the present disclosure;

FIG. 6 is a flowchart of a route optimization method according to another embodiment of the present disclosure;

FIG. 7 is a flowchart of a route optimization method according to another embodiment of the present disclosure;

FIG. 8 is a flowchart of a route optimization method according to another embodiment of the present disclosure;

FIG. 9 is a schematic flowchart of a route optimization process according to an embodiment of the present disclosure;

FIG. 10 is a schematic flowchart of a route optimization process according to another embodiment of the present disclosure;

FIG. 11 is a schematic flowchart of a route optimization process according to another embodiment of the present disclosure;

FIG. 12 is a schematic flowchart of a route optimization process according to another embodiment of the present disclosure;

FIG. 13 is a schematic flowchart of a route optimization process according to another embodiment of the present disclosure;

FIG. 14 is a flowchart of a route optimization method according to another embodiment of the present disclosure;

FIG. 15 is a flowchart of a route optimization method according to another embodiment of the present disclosure;

FIG. 16 is a schematic flowchart of a route optimization process according to another embodiment of the present disclosure;

FIG. 17 is a flowchart of a route optimization method according to another embodiment of the present disclosure;

FIG. 18 is a flowchart of a route optimization method according to another embodiment of the present disclosure;

FIG. 19 is a schematic flowchart of a route optimization process according to another embodiment of the present disclosure;

FIG. 20 is a block diagram of an MR according to an embodiment of the present disclosure;

FIG. 21 is a block diagram of an MR according to another embodiment of the present disclosure;

FIG. 22 is a block diagram of an LM according to another embodiment of the present disclosure;

FIG. 23 is a block diagram of an MR according to another embodiment of the present disclosure;

FIG. 24 is a block diagram of an LM according to another embodiment of the present disclosure;

FIG. 25 is a block diagram of an MR according to another embodiment of the present disclosure;

FIG. 26 is a block diagram of an LM according to another embodiment of the present disclosure;

FIG. 27 is a block diagram of an MR according to another embodiment of the present disclosure;

FIG. 28 is a block diagram of an MR according to another embodiment of the present disclosure;

FIG. 29 is a block diagram of a location manager entity according to another embodiment of the present disclosure;

FIG. 30 is a block diagram of a mobile router according to another embodiment of the present disclosure;

FIG. 31 is a block diagram of an LM according to another embodiment of the present disclosure;

FIG. 32 is a block diagram of an MR according to another embodiment of the present disclosure; and

FIG. 33 is a block diagram of an LM according to another embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are a part rather than all of the embodiments of the present disclosure. All other embodiments obtained by a person of ordinary skill in the art based on the embodiments of the present disclosure without creative efforts shall fall within the protection scope of the present disclosure.

It should be understood that in the embodiments of the present disclosure, UE is also referred to as a terminal, and includes but is not limited to a mobile station (MS), a mobile terminal, a mobile telephone, a mobile node (MN), a handset, portable equipment, and the like. The UE may communicate with one or more core networks using a radio access network (RAN). For example, the UE may be a mobile telephone (or referred to as a “cellular” telephone), or a computer that has a communication function. The UE may further be a portable, pocket-sized, handheld, computer built-in, or in-vehicle mobile apparatus.

It should be understood that the embodiments of the present disclosure are not only applicable to independent mobility management, but also applicable to centralized mobility management and DMM.

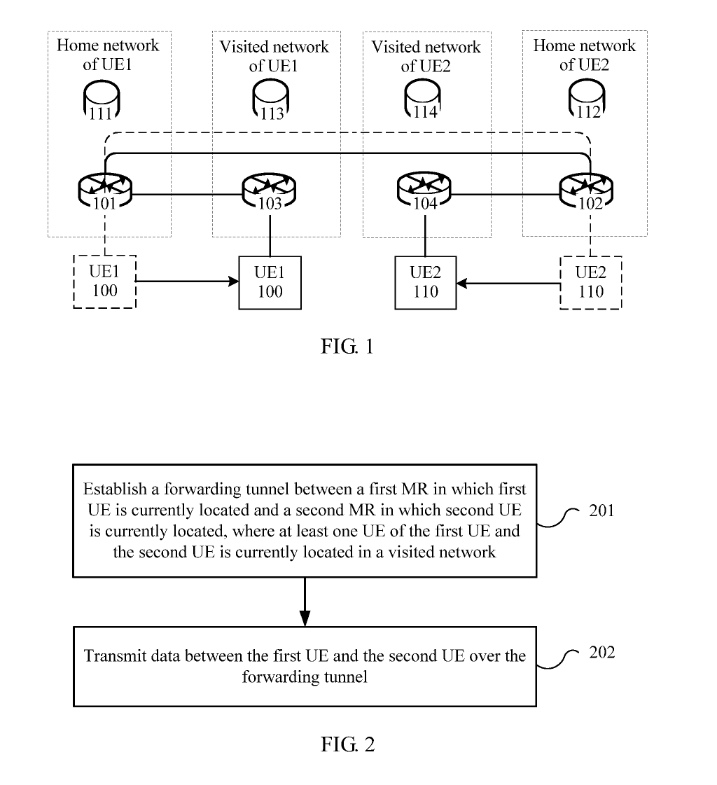

FIG. 1 is a schematic diagram of a mobility management architecture according to an embodiment of the present disclosure. In mobility management two logical entities includes an MR and an LM. Main functions of the MR are intercepting a packet of UE, and forwarding the packet to a correct destination. Main functions of the LM are managing and tracking a location of the UE such that the MR can route the packet of the UE to a correct address.

FIG. 1 shows a scenario of independent mobility management. 101, 102, 103, and 104 in FIG. 1 represent MRs, and 111, 112, 113, and 114 in FIG. 1 represent LMs. Each MR corresponds to one LM, and different LMs have different addresses. Furthermore, the MR 101 and the LM 111 are located in a home network of UE1 100, the MR 102 and the LM 112 are located in a home network of UE2 110, the MR 103 and the LM 113 are located in a visited network of the UE1 100, and the MR 104 and the LM 114 are located in a visited network of the UE2 110. When the UE1 100 and the UE2 110 are respectively located in the home network of the UE1 100 and the home network of the UE2 110, a data transmission path from the UE1 100 to the UE2 110 is the UE1 100, the MR101, the MR 102, and the UE2 110, as shown by a dashed line in FIG. 1.

When the UE1 100 moves to the visited network in which the MR 103 and the LM 113 are located, a forwarding tunnel is established between the MR 103 in the visited network and the MR 101 in the home network. Similarly, when the UE2 110 moves to the visited network in which the MR 104 and the LM 114 are located, a forwarding tunnel is also established between the MR 104 in the visited network and the MR 102 in the home network. In this case, a data transmission path from the UE1 100 to the UE2 110 is the UE1 100, the MR 103, the MR 101, the MR 102, the MR 104, and the UE2 110, as shown by a solid line in FIG. 1. That is, all data transmitted between the UE1 100 and the UE2 110 needs to pass through the home network, which directly causes a problem of route redundancy.

For ease of description, in the embodiments of the present disclosure, first UE is used as a transmit end, and second UE is used as a receive end, that is, the second UE is a correspondent node (CN) of the first UE.

FIG. 2 is a flowchart of a route optimization method according to an embodiment of the present disclosure. The method shown in FIG. 2 includes the following steps.

Step 201: Establish a forwarding tunnel between a first MR in which a first UE is currently located and a second MR in which a second UE is currently located, where at least one UE of the first UE and the second UE is currently located in a visited network.

Step 202: Transmit data between the first UE and the second UE over the forwarding tunnel.

According to this embodiment of the present disclosure, a forwarding tunnel is established between MRs in visited networks such that data is transmitted over the forwarding tunnel, which can reduce route redundancy.

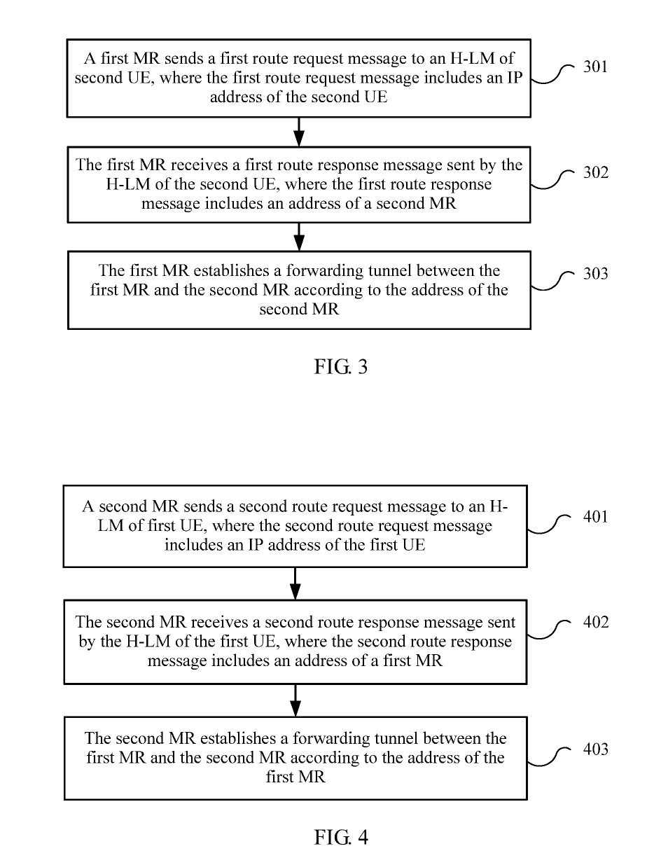

In step 201, the first MR may trigger to establish the forwarding tunnel between the first MR and the second MR, or the second MR may trigger to establish the forwarding tunnel between the first MR and the second MR. A method for establishing the forwarding tunnel is shown in FIG. 3 to FIG. 6.

FIG. 3 is a flowchart of a route optimization method according to another embodiment of the present disclosure. The method shown in FIG. 3 includes the following steps.

Step 301: A first MR sends a first route request message to an H-LM of a second UE, where the first route request message includes an IP address of the second UE.

Optionally, in an embodiment, before step 301, the first MR receives a packet sent by a first UE, the first MR acquires a destination address of the packet, that is, the IP address of the second UE, and then the first MR buffers the packet such that the packet is transmitted to the second UE over a forwarding tunnel after step 303.

In this way, according to the IP address of the second UE, the first MR may determine that an LM corresponding to the IP address of the second UE is the H-LM of the second UE. In addition, in step 301, the first MR may send the first route request message to the H-LM of the second UE.

Optionally, in another embodiment, when the first UE is currently located in a visited network, the first MR is a current mobile router (C-MR) of the first UE, that is, the first MR is an MR in the visited network in which the first UE is located, and it is assumed that an H-MR of the first UE is a third MR. Before step 301, the first MR receives the packet sent by the first UE, the first MR acquires a destination address of the packet, that is, the IP address of the second UE, then the first MR may send the packet to the third MR, and the third MR routes the packet to the second UE. Furthermore, when the first UE moves from a home network to the visited network, a first forwarding tunnel is first established between the first MR and the third MR such that data is transmitted between the first MR and the third MR.

Optionally, in another embodiment, when the first UE is currently located in a home network, the first MR is an H-MR of the first UE. In step 301, the first route request message sent by the first MR may include first flag bit information, and the first flag bit information is used to indicate that the first MR is the H-MR of the first UE, that is, the first flag bit information is used to indicate that the first UE is currently located in the home network.

Step 302: The first MR receives a first route response message sent by the H-LM of the second UE, where the first route response message includes an address of a second MR.

Optionally, in an embodiment, when the second UE is currently located in a visited network, the second MR is a C-MR of the second UE, that is, the second MR is an MR in the visited network in which the second UE is located.

Optionally, in another embodiment, when the first UE is currently located in a visited network and the second UE is currently located in a home network, the second MR is an H-MR of the second UE.

Optionally, in another embodiment, when the first UE is currently located in a visited network and the second UE is currently located in a home network, in step 302, the first route response message may further include second flag bit information, and the second flag bit information is used to indicate that the second MR is an H-MR of the second UE, that is, the second flag bit information is used to indicate that the second UE is currently located in the home network.

Step 303: The first MR establishes a forwarding tunnel between the first MR and the second MR according to the address of the second MR.

Optionally, in an embodiment, when the first route response message received by the first MR in step 302 includes the second flag bit information and the second flag bit information that indicates the second UE is currently located in the home network, the first MR needs to first determine that the first UE is currently located in the visited network, and then establish the forwarding tunnel between the first MR and the second MR.

Optionally, in an embodiment, in step 303, the first MR may send a first tunnel establishment request message to the second MR, and the first MR may receive a first tunnel establishment response message sent by the second MR in order to complete establishing the forwarding tunnel.

Optionally, in an embodiment, in step 303, the first MR may establish the forwarding tunnel between the first MR and the second MR according to the general packet radio service tunneling protocol (GTP). Further, the first tunnel establishment request message is a carrier request message, and the first tunnel establishment response message is a carrier response message.

Optionally, in an embodiment, in step 303, the first MR may establish the forwarding tunnel between the first MR and the second MR according to the proxy mobile IP (PMIP). Furthermore, the first tunnel establishment request message is a proxy binding update message, and the first tunnel establishment response message is a proxy binding confirmation message.

Optionally, in another embodiment, in step 303, the first MR may establish the forwarding tunnel in another manner, which is not limited in the present disclosure.

Optionally, in an embodiment, after step 303, the first MR routes and sends the buffered packet to the second MR over the forwarding tunnel established in step 303, and the packet is finally transmitted to the second UE.

Optionally, in another embodiment, after step 303, the first MR routes a received subsequent packet to the second UE over the forwarding tunnel established in step 303.

Optionally, after step 303, the first MR may bind the following information: an IP address of the first UE, the IP address of the second UE, the address of the second MR, and tunnel information of the forwarding tunnel. The present disclosure sets no limitation on a form of binding the information. For example, the information may be stored in the first MR in a form of a binding list.

According to this embodiment of the present disclosure, a forwarding tunnel is established between MRs in visited networks such that data is transmitted over the forwarding tunnel, which can reduce route redundancy.

FIG. 4 is a flowchart of a route optimization method according to another embodiment of the present disclosure. The method shown in FIG. 4 includes the following steps.

Step 401: A second MR sends a second route request message to an H-LM of a first UE, where the second route request message includes an IP address of the first UE.

Optionally, in an embodiment, when a second UE is currently located in a visited network, the second MR is a C-MR of the second UE, that is, the second MR is an MR in the visited network in which the second UE is located, and it is assumed that an H-MR of the second UE is a fourth MR. Before step 401, when the second UE moves from a home network to the visited network, a second forwarding tunnel is first established between the second MR and the fourth MR such that data is transmitted between the second MR and the fourth MR.

Step 402: The second MR receives a second route response message sent by the H-LM of the first UE, where the second route response message includes an address of a first MR.

Optionally, in an embodiment, when the first UE is currently located in a visited network, the first MR is a C-MR of the first UE, that is, the first MR is an MR in the visited network in which the first UE is located.

Optionally, in another embodiment, when the second UE is currently located in a visited network and the first UE is currently located in a home network, the first MR is an H-MR of the first UE.

Step 403: The second MR establishes a forwarding tunnel between the first MR and the second MR according to the address of the first MR.

Optionally, in an embodiment, in step 403, the second MR may send a second tunnel establishment request message to the first MR, and the second MR may receive a second tunnel establishment response message sent by the first MR in order to complete establishing the forwarding tunnel.

Optionally, in an embodiment, in step 403, the second MR may establish the forwarding tunnel between the first MR and the second MR according to the GTP. Furthermore, the second tunnel establishment request message is a carrier request message, and the second tunnel establishment response message is a carrier response message.

Optionally, in another embodiment, in step 403, the second MR may establish the forwarding tunnel between the first MR and the second MR according to the PMIP. Furthermore, the second tunnel establishment request message is a proxy binding update message, and the second tunnel establishment response message is a proxy binding confirmation message.

Optionally, in another embodiment, in step 403, the second MR may establish the forwarding tunnel in another manner, which is not limited in the present disclosure.

Optionally, after step 403, the second MR binds the following information: the IP address of the first UE, an IP address of the second UE, the address of the first MR, and tunnel information of the forwarding tunnel. The present disclosure sets no limitation on a form of binding the information. For example, the information may be stored in the second MR in a form of a binding list.

According to this embodiment of the present disclosure, a forwarding tunnel is established between MRs in visited networks such that data is transmitted over the forwarding tunnel, which can reduce route redundancy.

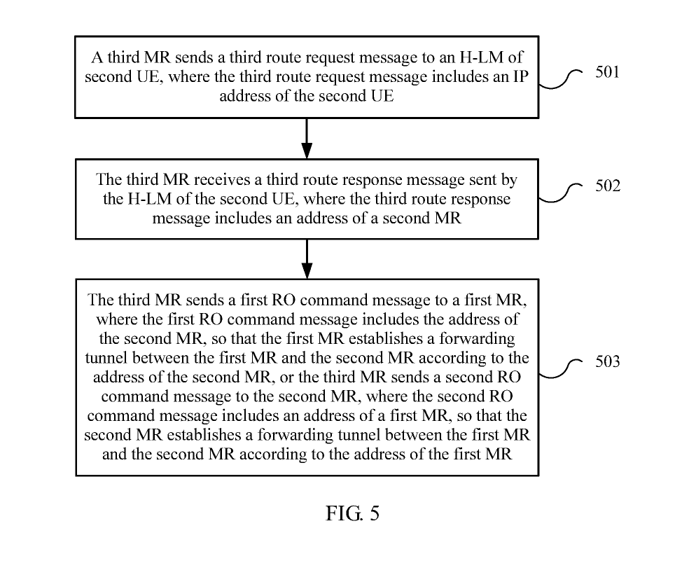

FIG. 5 is a flowchart of a route optimization method according to another embodiment of the present disclosure. When a first UE is currently located in a visited network, a first MR is a C-MR of the first UE, that is, the first MR is an MR in the visited network in which the first UE is located, and it is assumed that an H-MR of the first UE is a third MR. The method shown in FIG. 5 includes the following steps.

Step 501: The third MR sends a third route request message to an H-LM of a second UE, where the third route request message includes an IP address of the second UE.

Step 502: The third MR receives a third route response message sent by the H-LM of the second UE, where the third route response message includes an address of the second MR.

Optionally, in an embodiment, when the second UE is currently located in a visited network, the second MR is a C-MR of the second UE, that is, the second MR is an MR in the visited network in which the second UE is located.

Optionally, in another embodiment, when the second UE is currently located in a home network, the second MR is an H-MR of the second UE.

Step 503: The third MR sends a first RO command message to the first MR, where the first RO command message includes the address of the second MR, so that the first MR establishes a forwarding tunnel between the first MR and the second MR according to the address of the second MR, or the third MR sends a second RO command message to the second MR, where the second RO command message includes an address of the first MR, so that the second MR establishes a forwarding tunnel between the first MR and the second MR according to the address of the first MR.

Optionally, in an embodiment, the first RO command message may further include an IP address of the first UE and the IP address of the second UE. For a specific manner of establishing, by the first MR, the forwarding tunnel between the first MR and the second MR according to the address of the second MR, reference may be made to the description about step 303 in FIG. 3, and to avoid repetition, details are not repeated herein.

Optionally, in another embodiment, the second RO command message may further include an IP address of the first UE and the IP address of the second UE. For a specific manner of establishing, by the second MR, the forwarding tunnel between the first MR and the second MR according to the address of the first MR, reference may be made to the description about step 403 in FIG. 4, and to avoid repetition, details are not repeated herein.

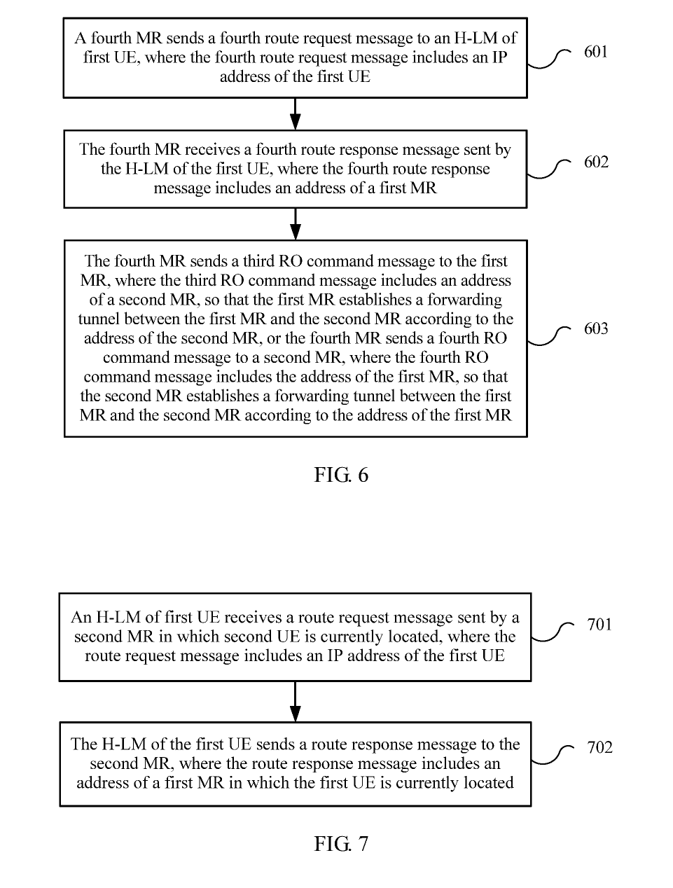

FIG. 6 is a flowchart of a route optimization method according to another embodiment of the present disclosure. When a second UE is currently located in a visited network, a second MR is a C-MR of the second UE, that is, the second MR is an MR in the visited network in which the second UE is located, and it is assumed that an H-MR of the second UE is a fourth MR. The method shown in FIG. 6 includes the following steps.

Step 601: The fourth MR sends a fourth route request message to an H-LM of a first UE, where the fourth route request message includes an IP address of the first UE.

Step 602: The fourth MR receives a fourth route response message sent by the H-LM of the first UE, where the fourth route response message includes an address of a first MR.

Optionally, in an embodiment, when the first UE is currently located in a visited network, the first MR is a C-MR of the first UE, that is, the first MR is an MR in the visited network in which the first UE is located.

Optionally, in another embodiment, when the first UE is currently located in a home network, the first MR is an H-MR of the first UE.

Step 603: The fourth MR sends a third RO command message to the first MR, where the third RO command message includes an address of the second MR, so that the first MR establishes a forwarding tunnel between the first MR and the second MR according to the address of the second MR, or the fourth MR sends a fourth RO command message to the second MR, where the fourth RO command message includes the address of the first MR, so that the second MR establishes a forwarding tunnel between the first MR and the second MR according to the address of the first MR.

Optionally, in an embodiment, the third RO command message may further include the IP address of the first UE and an IP address of the second UE. For a specific manner of establishing, by the first MR, the forwarding tunnel between the first MR and the second MR according to the address of the second MR, reference may be made to the description about step 303 in FIG. 3, and to avoid repetition, details are not repeated herein.

Optionally, in another embodiment, the fourth RO command message may further include the IP address of the first UE and an IP address of the second UE. For a specific manner of establishing, by the second MR, the forwarding tunnel between the first MR and the second MR according to the address of the first MR, reference may be made to the description about step 403 in FIG. 4, and to avoid repetition, details are not repeated herein.

In this way, step 201 in FIG. 2 may be implemented according to any method shown in FIG. 3 to FIG. 6. Optionally, in an embodiment, after the forwarding tunnel is established between the first MR and the second MR, the first MR may bind the following information: the IP address of the first UE, the IP address of the second UE, the address of the second MR, and tunnel information of the forwarding tunnel. The second MR may bind the following information: the IP address of the first UE, the IP address of the second UE, the address of the first MR, and tunnel information of the forwarding tunnel. It should be noted that the bound information in this embodiment of the present disclosure may be stored in a form of a binding list, or may be stored in another form, which is not limited in this embodiment of the present disclosure.

Optionally, in another embodiment, after the forwarding tunnel is established between the first MR and the second MR, when the first UE or the second UE moves such that the first UE is not located within a service range of the first MR or the second UE is not located within a service range of the second MR, the bound information in the first MR and the second MR may be unbound. Furthermore, if the forwarding tunnel is not shared by the first UE and the second UE with another user, the first MR or the second MR may trigger to release the forwarding tunnel.

Furthermore, the first MR may trigger to release the forwarding tunnel, which includes sending, by the first MR, a first tunnel release request message to the second MR, and receiving, by the first MR, a first tunnel release response message sent by the second MR in order to complete releasing the forwarding tunnel. Correspondingly, in FIG. 3 to FIG. 6, if the first MR or the second MR establishes the forwarding tunnel between the first MR and the second MR according to the GTP, the first tunnel release request message is a carrier deletion request message, and the first tunnel release response message is a carrier deletion response message. Correspondingly, in FIG. 3 to FIG. 6, if the first MR or the second MR establishes the forwarding tunnel between the first MR and the second MR according to the PMIP, the first tunnel release request message is a binding cancellation indication message, and the first tunnel release response message is a binding cancellation confirmation message.

Furthermore, the second MR may trigger to release the forwarding tunnel, which includes sending, by the second MR, a second tunnel release request message to the first MR, and receiving, by the second MR, a second tunnel release response message sent by the first MR in order to complete releasing the forwarding tunnel. Correspondingly, in FIG. 3 to FIG. 6, if the first MR or the second MR establishes the forwarding tunnel between the first MR and the second MR according to the GTP, the second tunnel release request message is a carrier deletion request message, and the second tunnel release response message is a carrier deletion response message. Correspondingly, in FIG. 3 to FIG. 6, if the first MR or the second MR establishes the forwarding tunnel between the first MR and the second MR according to the PMIP, the second tunnel release request message is a binding cancellation indication message, and the second tunnel release response message is a binding cancellation confirmation message.

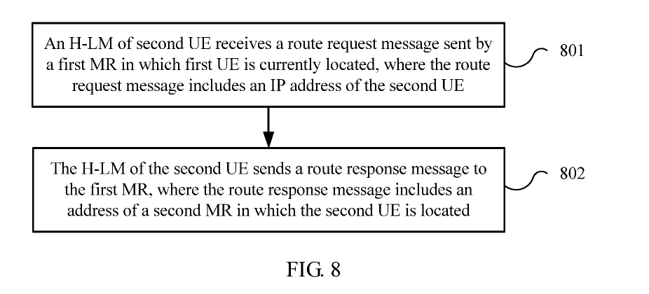

FIG. 7 is a flowchart of a route optimization method according to another embodiment of the present disclosure. At least one UE in a first UE and a second UE is currently located in a visited network. The method shown in FIG. 7 includes the following steps.

Step 701: An H-LM of the first UE receives a route request message sent by a second MR in which the second UE is currently located, where the route request message includes an IP address of the first UE.

Optionally, in an embodiment, when the second UE is currently located in a home network, the route request message may further include first flag bit information, and the first flag bit information is used to indicate that the second MR is an H-MR of the second UE.

Step 702: The H-LM of the first UE sends a route response message to the second MR, where the route response message includes an address of a first MR in which the first UE is currently located.

Optionally, in an embodiment, when the first UE is currently located in a home network, the route response message may further include second flag bit information, and the second flag bit information is used to indicate that the first MR is an H-MR of the first UE.

FIG. 8 is a flowchart of a route optimization method according to another embodiment of the present disclosure. At least one UE in a first UE and a second UE is currently located in a visited network. The method shown in FIG. 8 includes the following steps.

Step 801: An H-LM of the second UE receives a route request message sent by a first MR in which the first UE is currently located, where the route request message includes an IP address of the second UE.

Optionally, in an embodiment, when the first UE is currently located in a home network, the first MR is an H-MR of the first UE, and the route request message may include first flag bit information, and the first flag bit information is used to indicate that the first MR is the H-MR of the first UE, that is, the first flag bit information is used to indicate that the first UE is currently located in the home network.

Step 802: The H-LM of the second UE sends a route response message to the first MR, where the route response message includes an address of a second MR in which the second UE is located.

Optionally, in another embodiment, when the first UE is currently located in a visited network and the second UE is currently located in a home network, the route response message may further include second flag bit information, and the second flag bit information is used to indicate that the second MR is an H-MR of the second UE, that is, the second flag bit information is used to indicate that the second UE is currently located in the home network.

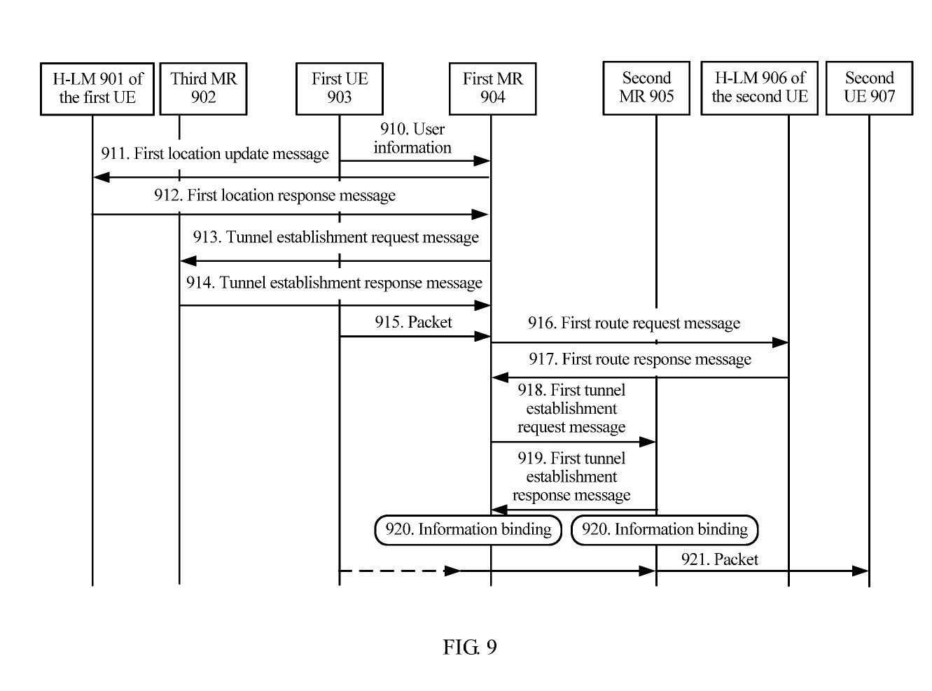

FIG. 9 is a schematic flowchart of a route optimization process according to an embodiment of the present disclosure. In FIG. 9, a first UE 903 is currently located in a visited network, and a second UE 907 is currently located in a home network. A first MR 904 is a C-MR of the first UE 903, a second MR 905 is an H-MR of the second UE 907, and a third MR 902 is an H-MR of the first UE 903. A process shown in FIG. 9 includes the following steps.

Step 910: When the first UE 903 moves from a home network to the visited network, the first MR 904 in the visited network acquires user information of the first UE 903, where the user information includes an IP address of the first UE 903.

Step 911: The first MR 904 sends a first location update message to an H-LM 901 of the first UE, where the first location update message includes the IP address of the first UE 903 and an address of the first MR 904.

Step 912: After receiving the first location update message, the H-LM 901 of the first UE records the address of the first MR 904 in the first location update message, and sends a first location response message to the first MR 904, where the first location response message includes an address of the third MR 902.

Step 913: The first MR 904 triggers to establish a first forwarding tunnel between the first MR 904 and the third MR 902, and the first MR 904 sends a tunnel establishment request message to the third MR 902.

Step 914: The first MR 904 receives a tunnel establishment response message sent by the third MR 902 in order to complete establishing the first forwarding tunnel between the first MR 904 and the third MR 902.

Optionally, in an embodiment, the first MR 904 may establish the first forwarding tunnel between the first MR 904 and the third MR 902 according to the GTP. The tunnel establishment request message in step 913 is a carrier request message, and the tunnel establishment response message in step 914 is a carrier response message.

Optionally, in another embodiment, the first MR 904 may establish the first forwarding tunnel between the first MR 904 and the third MR 902 according to the PMIP. The tunnel establishment request message in step 913 is a proxy binding update message, and the tunnel establishment response message in step 914 is a proxy binding confirmation message.

It should be noted that in step 911 to step 914 in this embodiment of the present disclosure, the method for establishing the first forwarding tunnel between the first MR 904 and the third MR 902 may be implemented in another form, which is not limited in this embodiment of the present disclosure.

Step 915: The first UE 903 sends a packet to the first MR 904, and the first MR 904 acquires a destination address of the packet, that is, an IP address of the second UE.

Furthermore, after receiving the packet, the first MR 904 acquires a source address and the destination address of the packet, which are respectively the IP address of the first UE 903 and the IP address of the second UE 907. The first MR 904 finds no tunnel information that is bound to the IP address of the first UE 903 and the IP address of the second UE 907, and the IP address of the first UE 903 is not allocated by the visited network in which the first MR 904 is located. In this case, the first MR 904 buffers the packet in the first MR 904.

Optionally, in another embodiment, the first MR 904 sends the packet to the third MR 902 over the first forwarding tunnel between the first MR 904 and the third MR 902 such that the third MR 902 sends the packet to the second UE 907 using the second MR 905.

Step 916: The first MR 904 sends a first route request message to an H-LM 906 of the second UE, where the first route request message includes the IP address of the second UE 907.

Optionally, in an embodiment, in a case of independent mobility management, each MR corresponds to one LM, and each LM has a different address. In this case, according to the IP address of the second UE 907, the first MR 904 can determine that an LM corresponding to the IP address of the second UE 907 is the H-LM 906 of the second UE.

Optionally, in another embodiment, in a case of centralized mobility management, only one LM exists, and therefore, an LM corresponding to the first MR 904 is also the H-LM 906 of the second UE.

Optionally, in another embodiment, in a case of DMM, different LMs corresponding to different MRs are interconnected. That is, for an MR, different LMs are equivalent to one LM, which is similar to the case of centralized mobility management.

Step 917: The first MR 904 receives a first route response message sent by the H-LM 906 of the second UE, where the first route response message includes an address of the second MR 905.

Optionally, in an embodiment, the first route response message may further include second flag bit information, and the second flag bit information is used to indicate that the second MR 905 is the H-MR of the second UE 907, that is, the second UE 907 is currently located in the home network.

Step 918: The first MR 904 triggers to establish a forwarding tunnel between the first MR 904 and the second MR 905, and the first MR 904 sends a first tunnel establishment request message to the second MR 905.

Optionally, in an embodiment, the first route response message received by the first MR 904 includes second flag bit information, that is, the first MR 904 has learned that the second UE 907 is currently located in the home network, and therefore, the first MR 904 needs to first determine that the first UE 903 is currently located in the visited network, and then trigger to establish the forwarding tunnel between the first MR 904 and the second MR 905.

Step 919: The first MR 904 receives a first tunnel establishment response message sent by the second MR 905 in order to complete establishing the forwarding tunnel.

Optionally, in an embodiment, the first MR 904 may establish the forwarding tunnel between the first MR 904 and the second MR 905 according to the GTP. The first tunnel establishment request message in step 918 is a carrier request message, and the first tunnel establishment response message in step 919 is a carrier response message.

Optionally, in another embodiment, the first MR 904 may establish the forwarding tunnel between the first MR 904 and the second MR 905 according to the PMIP, the first tunnel establishment request message in step 918 is a proxy binding update message, and the first tunnel establishment response message in step 919 is a proxy binding confirmation message.

Step 920: The first MR 904 binds the following information: the IP address of the first UE, the IP address of the second UE, the address of the second MR 905, and tunnel information of the forwarding tunnel, and the second MR 905 binds the following information: the IP address of the first UE, the IP address of the second UE, the address of the first MR 904, and the tunnel information of the forwarding tunnel.

Optionally, in an embodiment, the information bound by the first MR 904 may be stored in the first MR 904 in a form of a binding list. Table 1 shows a binding list that is stored by the first MR 904 and uses the IP address of the first UE as an index. The information bound by the second MR 905 may be stored in the second MR 905 in a form of a binding list. Table 2 shows a binding list that is stored by the second MR 905 and uses the IP address of the second UE as an index.

TABLE 1
IP address of the first UE

| | | |
|---|---|---|
| IP address of the | Address of the second | Tunnel information of the |
| second UE | MR | forwarding tunnel |

TABLE 2
IP address of the second UE

| | | |
|---|---|---|
| IP address of the first | Address of the first | Tunnel information of the |
| UE | MR | forwarding tunnel |

Optionally, in another embodiment, alternatively, the bound information may be stored in another form, which is not limited in the present disclosure.

Optionally, in another embodiment, if the forwarding tunnel is shared by the first UE 903 and the second UE 907 with other users, for example, a third UE and a fourth UE, the bound information may be stored in a form of a binding list. Table 3 shows a binding list that is stored by the first MR 904 and uses the address of the second MR 905 and the tunnel information of the forwarding tunnel as an index. The first row of Table 3 represents the index of the table, and two columns of other rows are a source address/destination address pair, for example, the first column represents a source address and the second column represents a destination address, or the first column represents a destination address and the second column represents a source address. Table 4 shows a binding list that is stored by the second MR 905 and uses the address of the first MR 904 and the tunnel information of the forwarding tunnel as an index. The first row of Table 4 represents the index of the table, and two columns of other rows are a source address/destination address pair, for example, the first column represents a source address and the second column represents a destination address, or the first column represents a destination address and the second column represents a source address.

TABLE 3

| Address of the second MR | Tunnel information of the forwarding tunnel |
|---|---|
| IP address of the first UE | IP address of the second UE |
| IP address of the third UE | IP address of the fourth UE |
| . . . | . . . |

TABLE 4

| Address of the first MR | Tunnel information of the forwarding tunnel |
|---|---|
| IP address of the first UE | IP address of the second UE |
| IP address of the third UE | IP address of the fourth UE |
| . . . | . . . |

Step 921: Transmit, to the second UE 907 over the forwarding tunnel, a subsequent packet sent by the first UE 903.

Furthermore, the subsequent packet sent by the first UE 903 arrives at the first MR 904, and is transmitted to the second MR 905 over the forwarding tunnel, and is finally transmitted to the second UE 907.

Optionally, in an embodiment, after the first MR 904 buffers the packet in step 915, and after step 919, the first MR 904 transmits the buffered packet to the second MR 905 over the forwarding tunnel, and finally the packet is transmitted to the second UE 907.

According to this embodiment of the present disclosure, a forwarding tunnel is established between MRs in visited networks such that data is transmitted over the forwarding tunnel, which can reduce route redundancy.

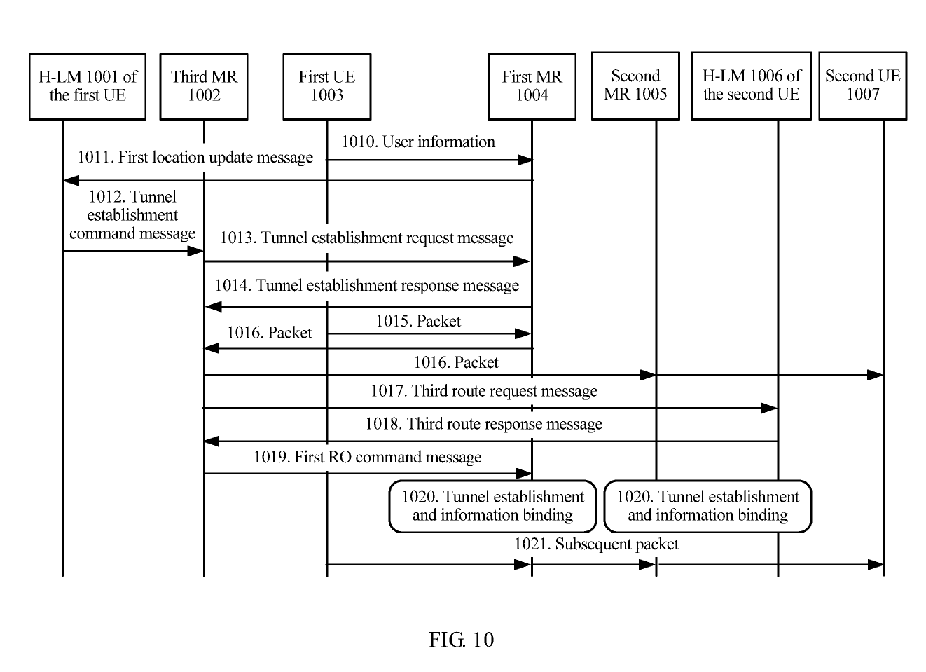

FIG. 10 is a schematic flowchart of a route optimization process according to another embodiment of the present disclosure. In FIG. 10, a first UE 1003 is currently located in a visited network, and a second UE 1007 is currently located in a home network. A first MR 1004 is a C-MR of the first UE 1003, a second MR 1005 is an H-MR of the second UE 1007, and a third MR 1002 is an H-MR of the first UE 1003. A process shown in FIG. 10 includes the following steps.

Step 1010: When the first UE 1003 moves from a home network to the visited network, the first MR 1004 in the visited network acquires user information of the first UE 1003, where the user information includes an IP address of the first UE 1003.

Furthermore, the IP address of the first UE 1003 is allocated by the home network of the first UE 1003.

Step 1011: The first MR 1004 sends a first location update message to an H-LM 1001 of the first UE, where the first location update message includes the IP address of the first UE 1003 and an address of the first MR 1004.

Step 1012: After receiving the first location update message, the H-LM 1001 of the first UE records the address of the first MR 1004 in the first location update message, and sends a tunnel establishment command message to the third MR 1002, where the tunnel establishment command message includes the address of the first MR 1004.

Step 1013: After receiving the tunnel establishment command message sent by the H-LM 1001 of the first UE, the third MR 1002 triggers to establish a first forwarding tunnel between the first MR 1004 and the third MR 1002, and the third MR 1002 sends a tunnel establishment request message to the first MR 1004.

Step 1014: The third MR 1002 receives a tunnel establishment response message sent by the first MR 1004 in order to complete establishing the first forwarding tunnel between the first MR 1004 and the third MR 1002.

Optionally, in an embodiment, the third MR 1002 may establish the first forwarding tunnel between the first MR 1004 and the third MR 1002 according to the GTP. The tunnel establishment request message in step 1013 is a carrier request message, and the tunnel establishment response message in step 1014 is a carrier response message.

Optionally, in another embodiment, the third MR 1002 may establish the first forwarding tunnel between the first MR 1004 and the third MR 1002 according to the PMIP. The tunnel establishment request message in step 1013 is a proxy binding update message, and the tunnel establishment response message in step 1014 is a proxy binding confirmation message.

It should be noted that establishment of the first forwarding tunnel between the first MR 1004 and the third MR 1002 may be implemented according to the method in step 1011 to step 1014 in this embodiment of the present disclosure, or may be implemented according to the method in step 911 to step 914 shown in FIG. 9, or may be implemented in another form, which is not limited in the present disclosure.

Step 1015: The first UE 1003 sends a packet to the first MR 1004.

Step 1016: The first MR 1004 sends the packet to the third MR 1002 such that the third MR 1002 routes the packet to the second UE 1007 using the second MR 1005.

Furthermore, in step 1015, after receiving the packet, the first MR 1004 acquires a source address and a destination address of the packet, which are respectively the IP address of the first UE 1003 and an IP address of the second UE 1007. The first MR 1004 finds no tunnel information that is bound to the IP address of the first UE 1003 and the IP address of the second UE 1007, and the IP address of the first UE 1003 is not allocated by the visited network in which the first MR 1004 is located. In this case, the first MR 1004 forwards the packet to the third MR 1002, and then the third MR 1002 routes the received packet to the destination address, that is, the second UE 1007.

Step 1017: The third MR 1002 initiates a route optimization process, the third MR 1002 sends a third route request message to an H-LM 1006 of the second UE, where the third route request message includes an IP address of the second UE.

Step 1018: The third MR 1002 receives a third route response message sent by the H-LM 1006 of the second UE, where the third route response message includes an address of the second MR 1005.

Step 1019: The third MR 1002 sends a first RO command message to the first MR 1004, where the first RO command message includes the IP address of the first UE 1003, the IP address of the second UE 1007, and the address of the second MR 1005.

Step 1020: The first MR 1004 receives the first RO command message and triggers to establish a forwarding tunnel between the first MR 1004 and the second MR 1005, and then the first MR 1004 and the second MR 1005 bind information.

Furthermore, for step 1020, reference may be made to steps 918 to 920 in FIG. 9, and to avoid repetition, details are not repeated herein.

Optionally, in an embodiment, in step 1019, the third MR 1002 may also send a second RO command message to the second MR 1005, where the second RO command message includes the IP address of the first UE 1003, the IP address of the second UE 1007, and the address of the first MR 1004. In addition, in step 1020, the second MR 1005 triggers to establish a forwarding tunnel between the first MR 1004 and the second MR 1005. Furthermore, the second MR 1005 sends a second tunnel establishment request message to the first MR 1004, and the second MR 1005 receives a second tunnel establishment response message sent by the first MR 1004 in order to complete establishing the forwarding tunnel between the first MR 1004 and the second MR 1005.

Step 1021: After arriving at the first MR 1004, a subsequent packet sent by the first UE 1003 is directly sent to the second MR 1005 over the forwarding tunnel, and is finally transmitted to the second UE 1007.

It should be noted that the embodiments shown in FIG. 9 and FIG. 10 are not only applicable to a scenario in which the first UE is currently located in the visited network and the second UE is currently located in the home network, but also applicable to a scenario in which both the first UE and the second UE are currently located in visited networks. To avoid repetition, details are not repeated herein.

FIG. 11 is a schematic flowchart of a route optimization process according to another embodiment of the present disclosure. In FIG. 11, a first UE 1103 is currently located in a home network, and a second UE 1107 is currently located in a visited network. A first MR 1104 is an H-MR of the first UE 1103, a second MR 1105 is a C-MR of the second UE 1107, and a fourth MR 1108 is an H-MR of the second UE 1107. A process shown in FIG. 11 includes the following steps.

Step 1110: When the second UE 1107 moves from a home network to the visited network, a second MR 1105 acquires user information of the second UE 1107, where the user information includes an IP address of the second UE 1107.

Further, the IP address of the second UE 1107 is allocated by the home network of the second UE 1107.

Step 1111: Establish a second forwarding tunnel between the second MR 1105 and the fourth MR 1108.

Further, similarly, for the method for establishing the second forwarding tunnel, reference may be made to the method for establishing the first forwarding tunnel between the first MR 904 and the third MR 902 in steps 911 to 914 in FIG. 9, or similarly, reference may be made to the method for establishing the first forwarding tunnel between the first MR 1004 and the third MR 1002 in steps 1011 to 1014 in FIG. 10, and to avoid repetition, details are not repeated herein.

Step 1112: The first UE 1103 sends a packet to the first MR 1104.

Step 1113: The first MR 1104 transmits the packet to the fourth MR 1108 according to a destination address of the packet, that is, an address of the second UE 1107, and then the fourth MR 1108 transmits the packet to the second MR 1105 over the second forwarding tunnel, and the packet finally arrives at the second UE 1107.

Step 1114: The first MR 1104 sends a first route request message to an H-LM 1106 of the second UE, where the first route request message includes an IP address of the second UE 1107 and first flag bit information H. The first flag bit information H is used to indicate that the first UE 1103 is currently located in the home network.

Step 1115: The H-LM 1106 of the second UE receives the first route request message, after parsing the first flag bit information H included in the first route request message, first determines that the second UE 1107 is currently located in the visited network, and then sends a first route response message to the first MR 1104, where the first route response message includes an address of the second MR 1105.

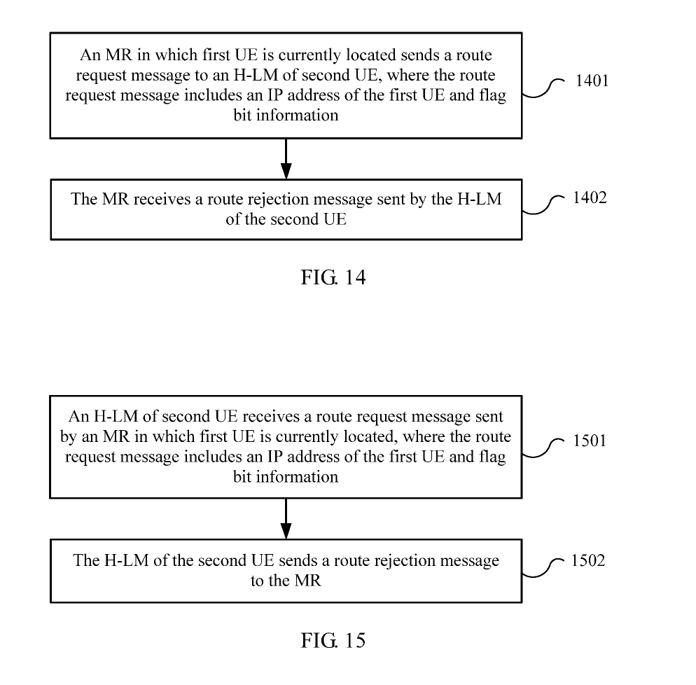

It should be noted that if the H-LM 1106 of the second UE receives the first route request message, parses the first flag bit information H included in the first route request message, and then determines that the second UE 1107 is also currently located in the home network, the H-LM 1106 of the second UE needs to send a first route rejection message to the first MR 1104 such that the first MR 1104 terminates a routing process. This case is further described in details in subsequent embodiments in FIG. 14 to FIG. 16.

Step 1116: After receiving the first route response message, the first MR 1104 triggers to establish a forwarding tunnel between the first MR 1104 and the second MR 1105.

Reference may be made to steps 918 and 919 in FIG. 9, and to avoid repetition, details are not repeated herein.

Step 1117: The first MR 1104 and the second MR 1105 separately establish information binding.

Reference may be made to step 920 in FIG. 9, and to avoid repetition, details are not repeated herein.

Step 1118: After arriving at the first MR 1104, a subsequent packet sent by the first UE 1103 is directly sent to the second MR 1105 over the forwarding tunnel, and is finally transmitted to the destination address, that is, the second UE 1107.

Step 1119: When the second UE 1107 moves out of a service range of the second MR 1105 and the forwarding tunnel is used only by the first UE 1103 and the second UE 1107, that is, when the forwarding tunnel is not shared by other users, the first MR 1104 triggers to release the forwarding tunnel, further the first MR 1104 sends a first tunnel release request message to the second MR 1105.

Step 1120: The first MR 1104 receives a first tunnel release response message sent by the second MR 1105 in order to complete releasing the forwarding tunnel.

Correspondingly, if the first MR 1104 or the second MR 1105 in step 1116 establishes the forwarding tunnel between the first MR 1104 and the second MR 1105 according to the GTP, the first tunnel release request message in step 1119 is a carrier deletion request message, and the first tunnel release response message in step 1120 is a carrier deletion response message. Correspondingly, if the first MR 1104 or the second MR 1105 in step 1116 establishes the forwarding tunnel between the first MR 1104 and the second MR 1105 according to the PMIP, the first tunnel release request message in step 1119 is a binding cancellation indication message, and the first tunnel release response message in step 1120 is a binding cancellation confirmation message.

Optionally, in another embodiment, in step 1119, alternatively, the second MR 1105 may trigger to release the forwarding tunnel. That is, in step 1119, the second MR 1105 may send a second tunnel release request message to the first MR 1104. Correspondingly, in step 1120, the second MR 1105 receives a second tunnel release response message sent by the first MR 1104 in order to complete releasing the forwarding tunnel.

Step 1121: When the forwarding tunnel is being released, the first MR 1104 and the second MR 1105 unbinds the information bound in step 1117.

In this way, according to this embodiment of the present disclosure, a forwarding tunnel is established between MRs in visited networks such that data is transmitted over the forwarding tunnel, which can reduce route redundancy.

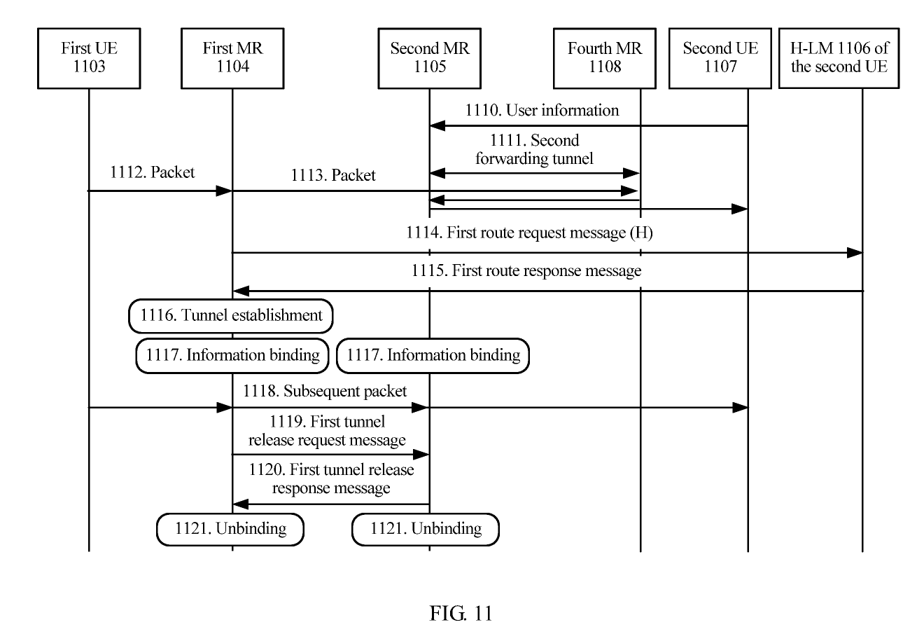

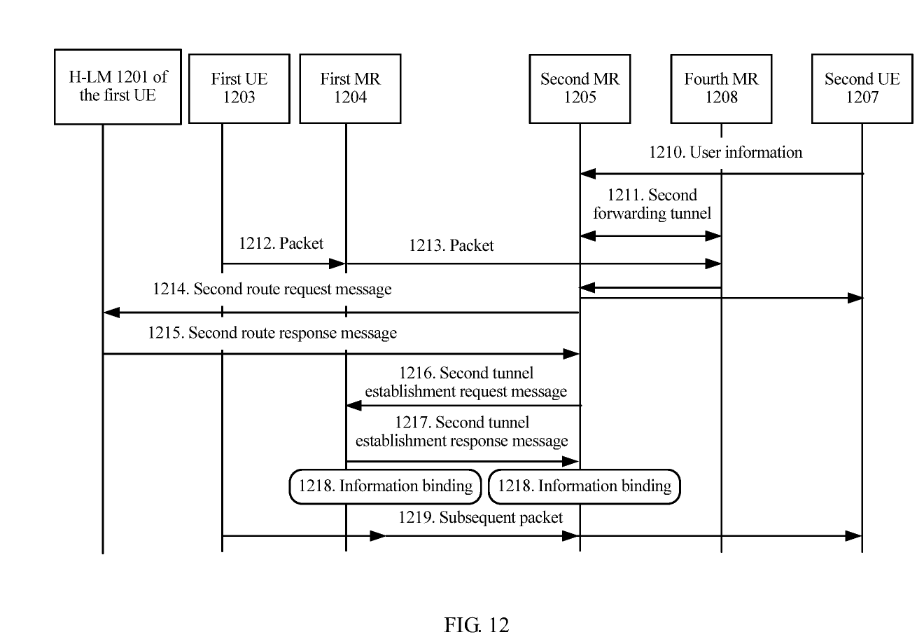

FIG. 12 is a schematic flowchart of a route optimization process according to another embodiment of the present disclosure. In FIG. 12, a first UE 1203 is currently located in a home network, and a second UE 1207 is currently located in a visited network. A first MR 1204 is an H-MR of the first UE 1203, a second MR 1205 is a C-MR of the second UE 1207, and a fourth MR 1208 is an H-MR of the second UE 1207. A process shown in FIG. 12 includes the following steps.

For steps 1210 to 1213, reference may be made to steps 1110 to 1113 in FIG. 11, and to avoid repetition, details are not repeated herein.

Step 1214: The second MR 1205 sends a second route request message to an H-LM 1201 of the first UE 1203, where the second route request message includes an IP address of the first UE 1203.

Step 1215: The second MR 1205 receives a second route response message sent by the H-LM 1201 of the first UE, where the second route response message includes an address of the first MR 1204.

Step 1216: The second MR 1205 triggers to establish a forwarding tunnel between the first MR 1204 and the second MR 1205, and the second MR 1205 sends a second tunnel establishment request message to the first MR 1204.

Step 1217: The second MR 1205 receives a second tunnel establishment response message sent by the first MR 1204 in order to complete establishing the forwarding tunnel.

Optionally, in an embodiment, the second MR 1205 may establish the forwarding tunnel between the first MR 1204 and the second MR 1205 according to the GTP. The second tunnel establishment request message in step 1216 is a carrier request message, and the second tunnel establishment response message in step 1217 is a carrier response message.

Optionally, in another embodiment, the second MR 1205 may establish the forwarding tunnel between the first MR 1204 and the second MR 1205 according to the PMIP. The second tunnel establishment request message in step 1216 is a proxy binding update message, and the second tunnel establishment response message in step 1217 is a proxy binding confirmation message.

For step 1218 and step 1219, reference may be made to steps 1117 and 1118 in FIG. 11, and to avoid repetition, details are not repeated herein.

In addition, in this embodiment of the present disclosure, for a step after step 1219, reference may also be made to steps 1119 to 1121 in FIG. 11, and to avoid repetition, details are not repeated herein.

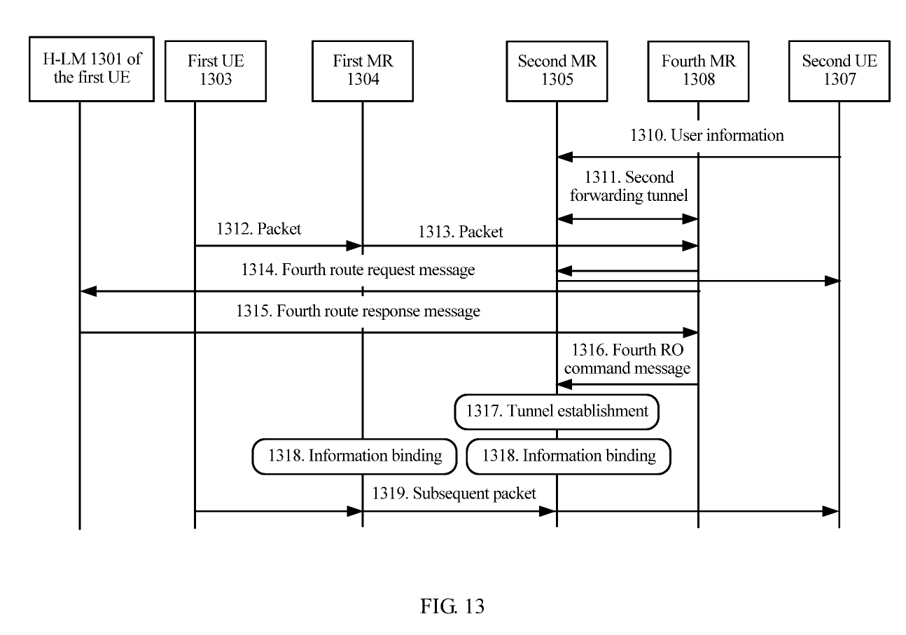

FIG. 13 is a schematic flowchart of a route optimization process according to another embodiment of the present disclosure. In FIG. 13, a first UE 1303 is currently located in a home network, and a second UE 1307 is currently located in a visited network. A first MR 1304 is an H-MR of the first UE 1303, a second MR 1305 is a C-MR of the second UE 1307, and a fourth MR 1308 is an H-MR of the second UE 1307. A process shown in FIG. 13 includes the following steps.

For steps 1310 to 1313, reference may be made to steps 1110 to 1113 in FIG. 11. To avoid repetition, details are not repeated herein.

Step 1314: The fourth MR 1308 initiates a route optimization process, where the fourth MR 1308 sends a fourth route request message to an H-LM 1301 of the first UE 1303, where the fourth route request message includes an IP address of the first UE 1303.

Step 1315: The fourth MR 1308 receives a fourth route response message sent by the H-LM 1301 of the first UE, where the fourth route response message includes an address of the first MR 1304.

Step 1316: The fourth MR 1308 sends a fourth RO command message to the second MR 1305, where the fourth RO command message includes the IP address of the first UE 1303, an IP address of the second UE 1307, and the address of the first MR 1304.

Step 1317: After receiving the fourth RO command message, the second MR 1305 triggers to establish a forwarding tunnel between the first MR 1304 and the second MR 1305.

Further, for step 1317, reference may be made to steps 1216 and 1217 in FIG. 12, and to avoid repetition, details are not repeated herein.

Optionally, in an embodiment, in step 1316, alternatively, the fourth MR 1308 may send a third RO command message to the first MR 1304, where the third RO command message includes the IP address of the first UE 1303, the IP address of the second UE 1307, and an address of the second MR 1305. In addition, in step 1317, the first MR 1304 triggers to establish the forwarding tunnel between the first MR 1304 and the second MR 1305.

For step 1318 and step 1319, reference may be made to steps 1117 and 1118 in FIG. 11, and to avoid repetition, details are not repeated herein.

In addition, in this embodiment of the present disclosure, for a step after step 1319, reference may also be made to steps 1119 to 1121 in FIG. 11, and to avoid repetition, details are not repeated herein.

It should be noted that the embodiments shown in FIG. 12 and FIG. 13 are not only applicable to a scenario in which the first UE is currently located in the home network and the second UE is currently located in the visited network, but also applicable to a scenario in which both the first UE and the second UE are currently located in visited networks. To avoid repetition, details are not repeated herein.

In this way, according to this embodiment of the present disclosure, a forwarding tunnel is established between MRs in visited networks such that data is transmitted over the forwarding tunnel, which can reduce route redundancy.

FIG. 14 is a flowchart of a route optimization method according to another embodiment of the present disclosure. The method shown in FIG. 14 includes the following steps.

Step 1401: An MR in which a first UE is currently located sends a route request message to an H-LM of a second UE, where the route request message includes an IP address of the first UE and flag bit information, and the flag bit information is used to indicate that the MR is an H-MR of the first UE, that is, the first UE is currently located in a home network.

Furthermore, the MR sends the route request message to the H-LM of the second UE to initiate a route optimization process.

Step 1402: The MR receives a route rejection message sent by the H-LM of the second UE.

Further, the MR receives the route rejection message and then terminates the route optimization process.

According to this embodiment of the present disclosure, for two UEs that are both currently located in home networks, flag bit information is added to identify whether the UEs are currently located in the home networks, and further determine whether a route optimization process needs to be performed.

FIG. 15 is a flowchart of a route optimization method according to another embodiment of the present disclosure. The method shown in FIG. 15 includes the following steps.

Step 1501: An H-LM of a second UE receives a route request message sent by an MR in which a first UE is currently located, where the route request message includes an IP address of the first UE and flag bit information, and the flag bit information is used to indicate that the MR is an H-MR of the first UE, that is, the first UE is currently located in a home network.

Step 1502: The H-LM of the second UE sends a route rejection message to the MR.

Further, the H-LM of the second UE receives the route request message, parses the flag bit information in the route request message to determine that the first UE is currently located in the home network, and then determines that the second UE is also currently located in a home network, and the H-LM of the second UE sends the route rejection message to the MR.

According to this embodiment of the present disclosure, for two UEs that are both currently located in home networks, flag bit information is added to identify whether the UEs are currently located in the home networks, and further determine whether a route optimization process needs to be performed.

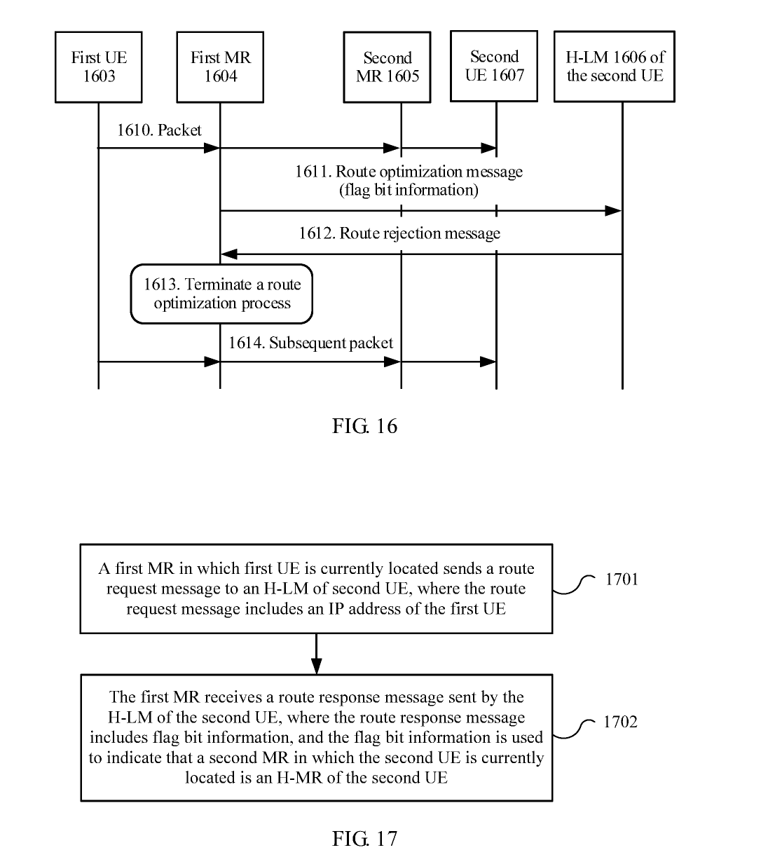

FIG. 16 is a schematic flowchart of a route optimization process according to another embodiment of the present disclosure. In FIG. 16, a first UE 1603 is currently located in a home network, and a second UE 1607 is currently located in a home network. A first MR 1604 is an H-MR of the first UE 1603, and a second MR 1605 is an H-MR of the second UE 1607. A process shown in FIG. 16 includes the following steps.

Step 1610: The first UE 1603 sends a packet.

Step 1611: The first MR 1604 initiates a route optimization process when sending the packet to the second UE 1607 according to a destination address of the packet. Further, the first MR 1604 sends a route optimization message to an H-LM 1606 of the second UE 1607, where the route optimization message includes an IP address of the second UE 1607 and flag bit information, and the flag bit information is used to indicate that the first UE 1603 is currently located in the home network.

Step 1612: The H-LM 1606 of the second UE 1607 receives a route request message, parses the flag bit information in the route request message to determine that the first UE 1603 is currently located in the home network, and then determines that the second UE 1607 is also currently located in the home network, and the H-LM 1606 of the second UE 1607 sends a route rejection message to the first MR 1604.

Step 1613: The first MR 1604 terminates the route optimization process according to the route rejection message.

Step 1614: A subsequent packet sent by the first UE 1603 to the first MR 1604 is transmitted to the second UE 1607 using the second MR 1605.

In this way, according to this embodiment of the present disclosure, flag bit information used to indicate that a UE is located in a home network is added into a route optimization process in order to determine whether route optimization needs to be performed, thereby avoiding establishing a tunnel when two UEs are located in home networks and reducing expenditure.

FIG. 17 is a flowchart of a route optimization method according to another embodiment of the present disclosure. The method includes the following steps.

Step 1701: A first MR in which a first UE is currently located sends a route request message to an H-LM of a second UE, where the route request message includes an IP address of the first UE.

Step 1702: The first MR receives a route response message sent by the H-LM of the second UE, where the route response message includes flag bit information, and the flag bit information is used to indicate that a second MR in which the second UE is currently located is an H-MR of the second UE, that is, the flag bit information is used to indicate that the second UE is currently located in a home network.

Further, the first MR receives the route response message, parses the flag bit information in the route response message to determine that the second UE is currently located in the home network, then determines that the first UE is also currently located in a home network, and terminates a route optimization process.

According to this embodiment of the present disclosure, for two UEs that are both currently located in home networks, flag bit information is added to identify whether the UEs are currently located in the home networks, and further determine whether a route optimization process needs to be performed.

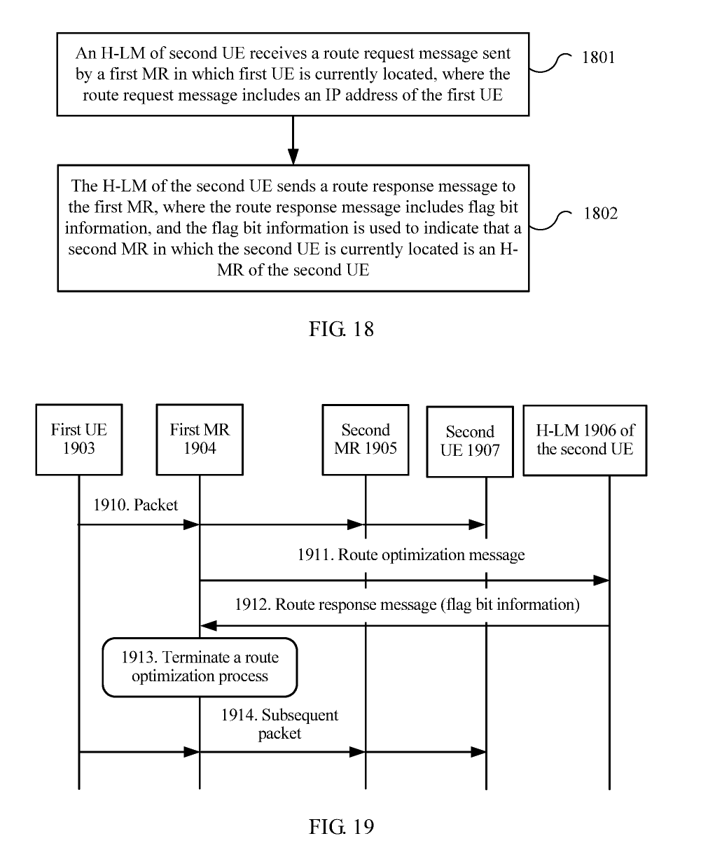

FIG. 18 is a flowchart of a route optimization method according to another embodiment of the present disclosure. The method includes the following steps.

Step 1801: An H-LM of a second UE receives a route request message sent by a first MR in which a first UE is currently located, where the route request message includes an IP address of the first UE.

Step 1802: The H-LM of the second UE sends a route response message to the first MR, where the route response message includes flag bit information, and the flag bit information is used to indicate that a second MR in which the second UE is currently located is an H-MR of the second UE.

According to this embodiment of the present disclosure, for two UEs that are both currently located in home networks, flag bit information is added to identify whether the UEs are currently located in the home networks, and further determine whether a route optimization process needs to be performed.

FIG. 19 is a schematic flowchart of a route optimization process according to another embodiment of the present disclosure. In FIG. 19, a first UE 1903 is currently located in a home network, and a second UE 1907 is currently located in a home network. A first MR 1904 is an H-MR of the first UE 1903, and a second MR 1905 is an H-MR of the second UE 1907. A process shown in FIG. 19 includes the following steps.

Step 1910: The first UE 1903 sends a packet.

Step 1911: The first MR 1904 initiates a route optimization process when sending the packet to the second UE 1907 according to a destination address of the packet. Further, the first MR 1904 sends a route optimization message to an H-LM 1906 of the second UE, where the route optimization message includes an IP address of the second UE 1907.

Step 1912: The H-LM 1906 of the second UE sends a route response message to the first MR 1904, where the route response message includes flag bit information, and the flag bit information is used to indicate that the second UE 1907 is currently located in the home network.

Step 1913: After receiving the route response message, the first MR 1904 parses the flag bit information in the route response message to determine that the second UE 1907 is currently located in the home network, and then determines that the first UE 1903 is also currently located in the home network, and terminates the route optimization process.

Step 1914: A subsequent packet sent by the first UE 1903 to the first MR 1904 is transmitted to the second UE 1907 using the second MR 1905.

In this way, according to this embodiment of the present disclosure, flag bit information used to indicate that a UE is located in a home network is added into a route optimization process in order to determine whether route optimization needs to be performed, thereby avoiding establishing a tunnel when two UEs are located in home networks and reducing expenditure.

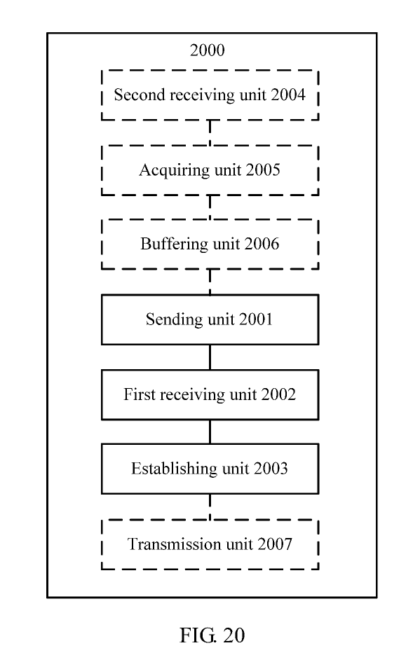

FIG. 20 is a block diagram of an MR according to an embodiment of the present disclosure. An MR 2000 in FIG. 20 is an MR in which a first UE is currently located, and the MR 2000 includes a sending unit 2001, a first receiving unit 2002, and an establishing unit 2003.

The sending unit 2001 is configured to send a route request message to an H-LM of a second UE, where the route request message includes an IP address of the second UE. The first receiving unit 2002 is configured to receive a route response message sent by the H-LM of the second UE, where the route response message includes an address of a second MR in which the second UE is currently located. The establishing unit 2003 is configured to establish a forwarding tunnel between the MR 2000 and the second MR according to the address of the second MR, where at least one UE of the first UE and the second UE is currently located in a visited network.

According to this embodiment of the present disclosure, a forwarding tunnel is established between MRs in visited networks such that data is transmitted over the forwarding tunnel, which can reduce route redundancy.

Optionally, in an embodiment, the MR 2000 may further include a second receiving unit 2004, an acquiring unit 2005, a buffering unit 2006, and a transmission unit 2007.

The second receiving unit 2004 is configured to receive a packet sent by the first UE. The acquiring unit 2005 is configured to acquire the IP address of the second UE in the packet received by the second receiving unit 2004. The buffering unit 2006 is configured to buffer the packet received by the second receiving unit 2004. The transmission unit 2007 is configured to transmit, to the second MR over the forwarding tunnel established by the establishing unit 2003, the packet buffered by the buffering unit 2006.

Optionally, in an embodiment, when the first UE is currently located in a home network, the route request message sent by the sending unit 2001 may further include first flag bit information, and the first flag bit information is used to indicate that the MR 2000 is an H-MR of the first UE.

Optionally, in another embodiment, when the second UE is currently located in a home network, the route response message received by the first receiving unit 2002 may further include second flag bit information, and the second flag bit information is used to indicate that the second MR is an H-MR of the second UE.

Optionally, in another embodiment, the establishing unit 2003 may further include a first sending subunit and a first receiving subunit.

The first sending subunit is configured to send a first tunnel establishment request message to the second MR. The first receiving subunit is configured to receive a first tunnel establishment response message sent by the second MR in order to complete establishing the forwarding tunnel.

Optionally, in another embodiment, the establishing unit 2003 may further include a second receiving subunit and a second sending subunit.

The second receiving subunit is configured to receive a second tunnel establishment request message sent by the second MR. The second sending subunit is configured to send a second tunnel establishment response message to the second MR in order to complete establishing the forwarding tunnel.

Optionally, in another embodiment, the MR 2000 may further include a binding unit configured to bind the following information: an IP address of the first UE, the IP address of the second UE, the address of the second MR, and tunnel information of the forwarding tunnel.

Optionally, in another embodiment, the MR 2000 may further include an unbinding unit configured to unbind the information when the first UE is currently located in a visited network and the first UE is not currently located within a service range of the MR 2000 any longer, or when the second UE is currently located in a visited network and the second UE is not currently located within a service range of the second MR any longer.

Optionally, in another embodiment, the MR 2000 may further include a releasing unit configured to release the forwarding tunnel when the forwarding tunnel is not shared by another UE.

Optionally, in an embodiment, the releasing unit may include a third sending subunit and a third receiving subunit.

The third sending subunit is configured to send a first tunnel release request message to the second MR. The third receiving subunit is configured to receive a first tunnel release response message sent by the second MR in order to complete releasing the forwarding tunnel.

Optionally, in another embodiment, the releasing unit may include a fourth receiving subunit and a fourth sending subunit.

The fourth receiving subunit is configured to receive a second tunnel release request message sent by the second MR. The fourth sending subunit is configured to send a second tunnel release response message to the second MR in order to complete releasing the forwarding tunnel.

FIG. 21 is a block diagram of an MR according to another embodiment of the present disclosure. An MR 2100 in FIG. 21 is an H-MR of a first UE, and the MR 2100 includes a first sending unit 2101, a receiving unit 2102, and a second sending unit 2103.

The first sending unit 2101 is configured to send a route request message to an H-LM of a second UE, where the route request message includes an IP address of the second UE. The receiving unit 2102 is configured to receive a route response message sent by the H-LM of the second UE, where the route response message includes an address of a second MR in which the second UE is currently located. The second sending unit 2103 is configured to send a first RO command message to a first MR in which the first UE is currently located, where the first RO command message includes the address of the second MR, and the first RO command message is used by the first MR to establish a forwarding tunnel between the first MR and the second MR according to the address of the second MR, or configured to send a second RO command message to the second MR, where the second RO command message includes an address of the first MR, and the second RO command message is used by the second MR to establish a forwarding tunnel between the first MR and the second MR according to the address of the first MR, where the first UE is currently located in a visited network.

According to this embodiment of the present disclosure, a forwarding tunnel is established between MRs in visited networks such that data is transmitted over the forwarding tunnel, which can reduce route redundancy.

FIG. 22 is a block diagram of an LM according to another embodiment of the present disclosure. An LM 2200 in FIG. 22 is an H-LM of a first UE, and the LM 2200 includes a receiving unit 2201 and a sending unit 2202.

The receiving unit 2201 is configured to receive a route request message sent by a second MR in which a second UE is currently located, where the route request message includes an IP address of the first UE. The sending unit 2202 is configured to send a route response message to the second MR, where the route response message includes an address of a first MR in which the first UE is currently located, where at least one UE of the first UE and the second UE is currently located in a visited network.

Optionally, in an embodiment, when the second UE is currently located in a home network, the route request message received by the receiving unit 2201 may further include first flag bit information, where the first flag bit information is used to indicate that the second MR is an H-MR of the second UE.

Optionally, in another embodiment, when the first UE is currently located in a home network, the route response message sent by the sending unit 2202 may further include second flag bit information, where the second flag bit information is used to indicate that the first MR is an H-MR of the first UE.

According to this embodiment of the present disclosure, a forwarding tunnel is established between MRs in visited networks such that data is transmitted over the forwarding tunnel, which can reduce route redundancy.

FIG. 23 is a block diagram of an MR according to another embodiment of the present disclosure. An MR 2300 shown in FIG. 23 is an MR in which a first UE is currently located, and the MR 2300 includes a sending unit 2301, and a receiving unit 2302.

The sending unit 2301 is configured to send a route request message to an H-LM of second UE, where the route request message includes an IP address of the first UE and flag bit information, and the flag bit information is used to indicate that the MR 2300 is an H-MR of the first UE. The receiving unit 2302 is configured to receive a route rejection message sent by the H-LM of the second UE.

According to this embodiment of the present disclosure, for two UEs that are both currently located in home networks, flag bit information is added to identify whether the UEs are currently located in the home networks, and further determine whether a route optimization process needs to be performed.

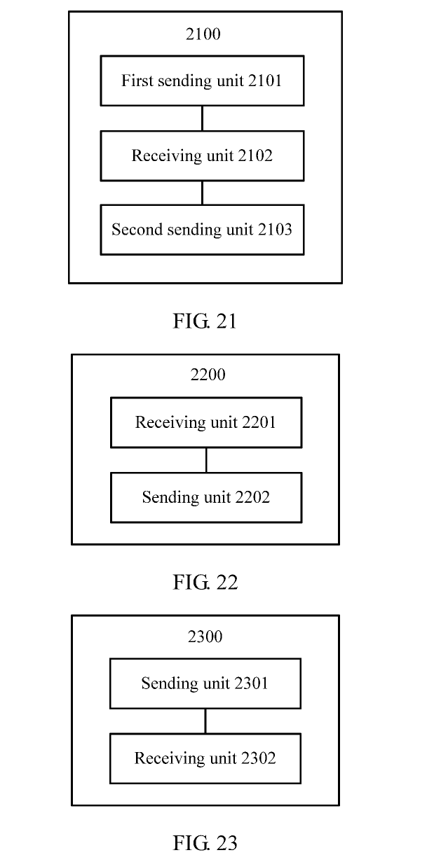

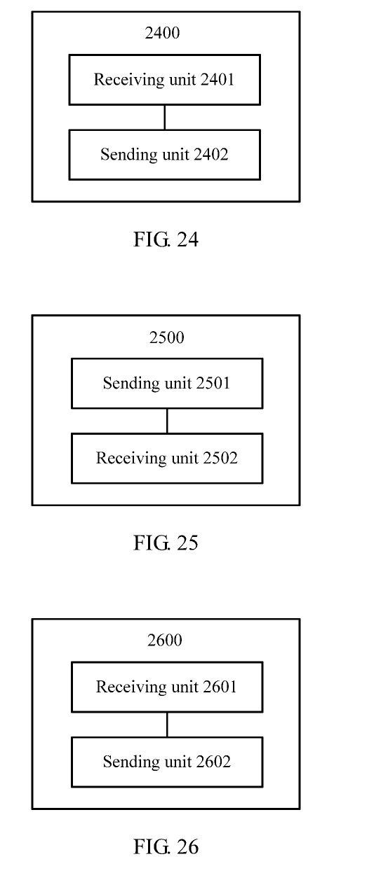

FIG. 24 is a block diagram of an LM according to another embodiment of the present disclosure. An LM 2400 shown in FIG. 24 is an H-LM of a second UE, and the LM 2400 includes a receiving unit 2401 and a sending unit 2402.

The receiving unit 2401 is configured to receive a route request message sent by an MR in which a first UE is currently located, where the route request message includes an IP address of the first UE and flag bit information, and the flag bit information is used to indicate that the MR is an H-MR of the first UE. The sending unit 2402 is configured to send a route rejection message to the MR.

According to this embodiment of the present disclosure, for two UEs that are both currently located in home networks, flag bit information is added to identify whether the UEs are currently located in the home networks, and further determine whether a route optimization process needs to be performed.

FIG. 25 is a block diagram of an MR according to another embodiment of the present disclosure. An MR 2500 shown in FIG. 25 is an MR in which a first UE is currently located, and the MR 2500 includes a sending unit 2501 and a receiving unit 2502.

The sending unit 2501 is configured to send a route request message to an H-LM of a second UE, where the route request message includes an IP address of the first UE. The receiving unit 2502 is configured to receive a route response message sent by the H-LM of the second UE, where the route response message includes flag bit information, and the flag bit information is used to indicate that a second MR in which the second UE is currently located is an H-MR of the second UE, where the first UE is currently located in a home network.

In this way, according to this embodiment of the present disclosure, flag bit information used to indicate that UE is located in a home network is added into a route optimization process in order to determine whether route optimization needs to be performed, thereby avoiding establishing a tunnel when both two UEs are located in home networks and reducing expenditure.

FIG. 26 is a block diagram of an LM according to another embodiment of the present disclosure. An LM 2600 shown in FIG. 26 is an H-LM of a second UE, and the LM 2600 includes a receiving unit 2601 and a sending unit 2601.

The receiving unit 2601 is configured to receive a route request message sent by a first MR in which a first UE is currently located, where the route request message includes an IP address of the first UE. The sending unit 2602 is configured to send a route response message to the first MR, where the route response message includes flag bit information, and the flag bit information is used to indicate that a second MR in which the second UE is currently located is an H-MR of the second UE such that the first MR terminates a route optimization process, where the first UE is currently located in a home network.

In this way, according to this embodiment of the present disclosure, flag bit information used to indicate that UE is located in a home network is added into a route optimization process in order to determine whether route optimization needs to be performed, thereby avoiding establishing a tunnel when both two UEs are located in home networks and reducing expenditure.

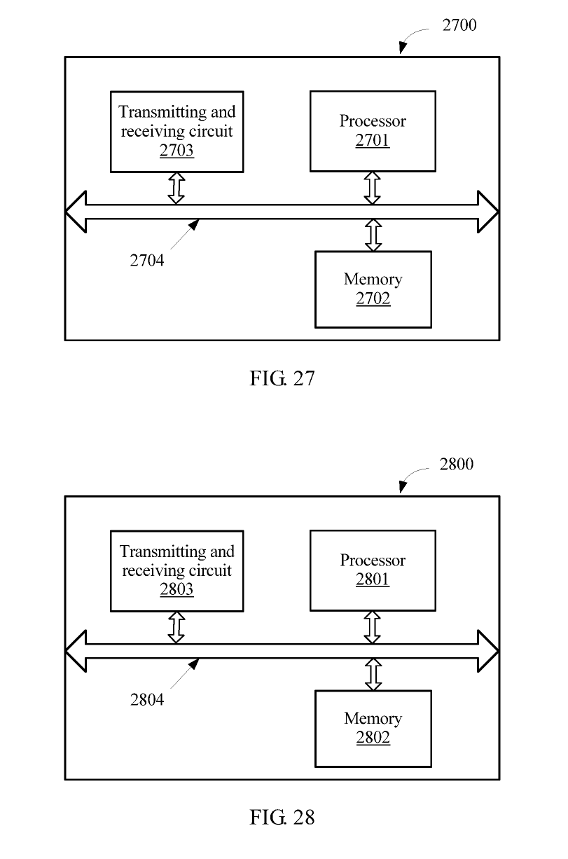

FIG. 27 is a block diagram of an MR according to another embodiment of the present disclosure. An MR 2700 in FIG. 27 is an MR in which a first UE is currently located, and the MR 2700 includes a processor 2701, a memory 2702, and a transmitting and receiving circuit 2703.

The transmitting and receiving circuit 2703 is configured to send a route request message to an H-LM of a second UE, where the route request message includes an IP address of the second UE, and is further configured to receive a route response message sent by the H-LM of the second UE, where the route response message includes an address of a second MR in which the second UE is currently located. The processor 2701 is configured to establish a forwarding tunnel between the MR 2700 and the second MR according to the address of the second MR, where at least one UE of the first UE and the second UE is currently located in a visited network.

According to this embodiment of the present disclosure, a forwarding tunnel is established between MRs in visited networks such that data is transmitted over the forwarding tunnel, which can reduce route redundancy.

Components in the MR 2700 are coupled together using a bus system 2704, where in addition to a data bus, the bus system 2704 includes a power supply bus, a control bus, and a status signal bus. However, for clarity of description, various buses are marked as the bus system 2704 in FIG. 27.

The foregoing methods disclosed in the embodiments of the present disclosure may be applied to the processor 2701, or implemented by the processor 2701. The processor 2701 may be an integrated circuit chip and has a signal processing capability. In an implementation process, the steps of the foregoing methods may be completed using an integrated logic circuit of hardware in the processor 2701 or an instruction in a form of software. The processor 2701 may be a general purpose processor, a digital signal processor (DSP), an application-specific integrated circuit (ASIC), a field programmable gate array (FPGA) or another programmable logic device, a discrete gate or transistor logic device, or a discrete hardware assembly. The processor 2701 can implement or execute the methods, the steps, and the logical block diagrams disclosed in the embodiments of the present disclosure. The general purpose processor may be a microprocessor, or the processor may be any conventional processor or the like. The steps of the methods disclosed with reference to the embodiments of the present disclosure may be directly implemented by means of a hardware decoding processor, or may be implemented using a combination of hardware and software modules in the decoding processor. The software module may be located in a mature storage medium in the art, such as a random access memory (RAM), a flash memory, a read-only memory (ROM), a programmable read-only memory, an electrically erasable programmable memory, or a register. The storage medium is located in the memory 2702, and the processor 2701 reads information in the memory 2702 and completes the steps of the foregoing methods in combination with hardware of the processor 2701.

Optionally, in an embodiment, the transmitting and receiving circuit 2703 may be configured to receive a packet sent by the first UE. The processor 2701 is configured to acquire the IP address of the second UE in the packet received by the transmitting and receiving circuit 2703, buffer the packet received by the transmitting and receiving circuit 2703, and further, transmit the packet to the second MR over the forwarding tunnel.

Optionally, in an embodiment, when the first UE is currently located in a home network, the route request message sent by the transmitting and receiving circuit 2703 may further include first flag bit information, and the first flag bit information is used to indicate that the MR 2700 is an H-MR of the first UE.

Optionally, in another embodiment, when the second UE is currently located in a home network, the route response message received by the transmitting and receiving circuit 2703 may further include second flag bit information, and the second flag bit information is used to indicate that the second MR is an H-MR of the second UE.

Optionally, in another embodiment, the transmitting and receiving circuit 2703 may be further configured to send a first tunnel establishment request message to the second MR, and further, receive a first tunnel establishment response message sent by the second MR in order to complete establishing the forwarding tunnel.

Optionally, in another embodiment, the transmitting and receiving circuit 2703 may be configured to receive a second tunnel establishment request message sent by the second MR, and further configured to send a second tunnel establishment response message to the second MR in order to complete establishing the forwarding tunnel.

Optionally, in another embodiment, the processor 2701 may be further configured to bind the following information: an IP address of the first UE, the IP address of the second UE, the address of the second MR, and tunnel information of the forwarding tunnel.

Optionally, in another embodiment, the processor 2701 may be further configured to unbind the information when the first UE is currently located in a visited network and the first UE is not currently located within a service range of the MR 2700 any longer, or when the second UE is currently located in a visited network and the second UE is not currently located within a service range of the second MR any longer.

Optionally, in another embodiment, the processor 2701 may be further configured to release the forwarding tunnel when the forwarding tunnel is not shared by another UE.

Optionally, in an embodiment, the transmitting and receiving circuit 2703 may be configured to send a first tunnel release request message to the second MR, and further, receive a first tunnel release response message sent by the second MR in order to complete releasing the forwarding tunnel.

Optionally, in another embodiment, the transmitting and receiving circuit 2703 may be configured to receive a second tunnel release request message sent by the second MR, and further, send a second tunnel release response message to the second MR in order to complete releasing the forwarding tunnel.

The MR 2700 can implement each process implemented by the first MR in the embodiment in FIG. 3, and to avoid repetition, details are not repeated herein.

FIG. 28 is a block diagram of an MR according to another embodiment of the present disclosure. An MR 2800 in FIG. 28 is an H-MR of a first UE, and the MR 2800 includes a processor 2801, a memory 2802, and a transmitting and receiving circuit 2803.

The transmitting and receiving circuit 2803 is configured to send a route request message to an H-LM of a second UE, where the route request message includes an IP address of the second UE, receive a route response message sent by the H-LM of the second UE, where the route response message includes an address of a second MR in which the second UE is currently located, and further, send a first RO command message to a first MR in which the first UE is currently located, where the first RO command message includes the address of the second MR, and the first RO command message is used by the first MR to establish a forwarding tunnel between the first MR and the second MR according to the address of the second MR, or send a second RO command message to the second MR, where the second RO command message includes an address of the first MR, and the second RO command message is used by the second MR to establish a forwarding tunnel between the first MR and the second MR according to the address of the first MR, where the first UE is currently located in a visited network.

According to this embodiment of the present disclosure, a forwarding tunnel is established between MRs in visited networks such that data is transmitted over the forwarding tunnel, which can reduce route redundancy.

Components in the MR 2800 are coupled together using a bus system 2804, where in addition to a data bus, the bus system 2804 includes a power supply bus, a control bus, and a status signal bus. However, for clarity of description, various buses are marked as the bus system 2804 in FIG. 28.

The foregoing methods disclosed in the embodiments of the present disclosure may be applied to the processor 2801, or implemented by the processor 2801. The processor 2801 may be an integrated circuit chip and has a signal processing capability. In an implementation process, the steps of the foregoing methods may be completed using an integrated logic circuit of hardware in the processor 2801 or an instruction in a form of software. The processor 2801 may be a general purpose processor, a DSP, an ASIC, an FPGA or another programmable logic device, a discrete gate or transistor logic device, or a discrete hardware assembly. The processor 2801 can implement or execute the methods, the steps, and the logical block diagrams disclosed in the embodiments of the present disclosure. The general purpose processor may be a microprocessor, or the processor may be any conventional processor or the like. The steps of the methods disclosed with reference to the embodiments of the present disclosure may be directly implemented by means of a hardware decoding processor, or may be implemented using a combination of hardware and software modules in the decoding processor. The software module may be located in a mature storage medium in the art, such as a RAM, a flash memory, a ROM, a programmable read-only memory, an electrically erasable programmable memory, or a register. The storage medium is located in the memory 2802, and the processor 2801 reads information in the memory 2802 and completes the steps of the foregoing methods in combination with hardware of the processor 2801.

The MR 2800 can implement each process implemented by the third MR in the embodiment in FIG. 5, and to avoid repetition, details are not repeated herein.

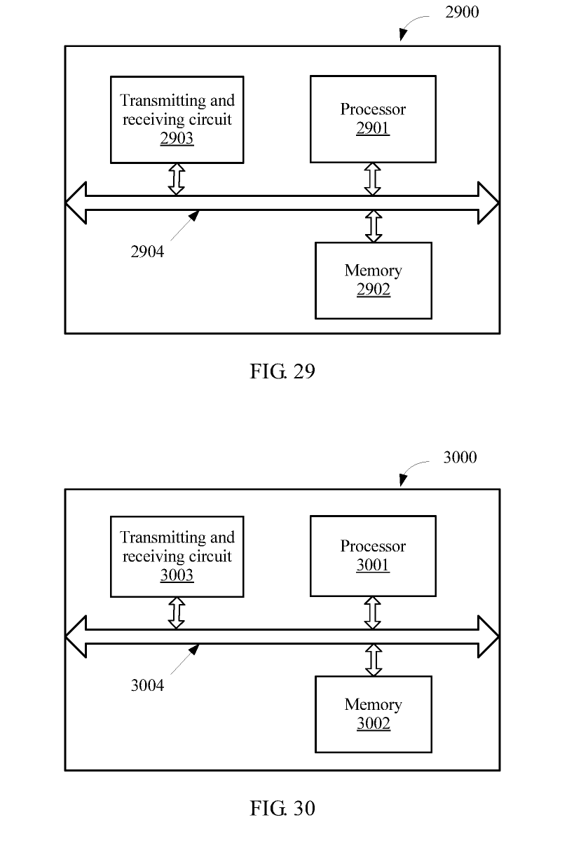

FIG. 29 is a block diagram of an LM according to another embodiment of the present disclosure. An LM 2900 in FIG. 29 is an H-LM of a first UE, and the LM 2900 includes a processor 2901, a memory 2902, and a transmitting and receiving circuit 2903.

The transmitting and receiving circuit 2903 is configured to receive a route request message sent by a second MR in which a second UE is currently located, where the route request message includes an IP address of the first UE, and send a route response message to the second MR, where the route response message includes an address of a first MR in which the first UE is currently located, where at least one UE of the first UE and the second UE is currently located in a visited network.

According to this embodiment of the present disclosure, a forwarding tunnel is established between MRs in visited networks such that data is transmitted over the forwarding tunnel, which can reduce route redundancy.

Components in the MR 2900 are coupled together using a bus system 2904, where in addition to a data bus, the bus system 2904 includes a power supply bus, a control bus, and a status signal bus. However, for clarity of description, various buses are marked as the bus system 2904 in FIG. 29.

The foregoing methods disclosed in the embodiments of the present disclosure may be applied to the processor 2901, or implemented by the processor 2901. The processor 2901 may be an integrated circuit chip and has a signal processing capability. In an implementation process, the steps of the foregoing methods may be completed using an integrated logic circuit of hardware in the processor 2901 or an instruction in a form of software. The processor 2901 may be a general purpose processor, a DSP, an ASIC, an FPGA or another programmable logic device, a discrete gate or transistor logic device, or a discrete hardware assembly. The processor 2901 can implement or execute the methods, the steps, and the logical block diagrams disclosed in the embodiments of the present disclosure. The general purpose processor may be a microprocessor, or the processor may be any conventional processor or the like. The steps of the methods disclosed with reference to the embodiments of the present disclosure may be directly implemented by means of a hardware decoding processor, or may be implemented using a combination of hardware and software modules in the decoding processor. The software module may be located in a mature storage medium in the art, such as a RAM, a flash memory, a ROM, a programmable read-only memory, an electrically erasable programmable memory, or a register. The storage medium is located in the memory 2902, and the processor 2901 reads information in the memory 2902 and completes the steps of the foregoing methods in combination with hardware of the processor 2901.

Optionally, in an embodiment, when the second UE is currently located in a home network, the route request message received by the transmitting and receiving circuit 2903 may further include first flag bit information, where the first flag bit information is used to indicate that the second MR is an H-MR of the second UE.

Optionally, in another embodiment, when the first UE is currently located in a home network, the route response message sent by the transmitting and receiving circuit 2903 may further include second flag bit information, where the second flag bit information is used to indicate that the first MR is an H-MR of the first UE.

The LM 2900 can implement each process implemented by the H-LM of the first UE in the embodiment in FIG. 7. To avoid repetition, details are not repeated herein.

FIG. 30 is a block diagram of an MR according to another embodiment of the present disclosure. An MR 3000 shown in FIG. 30 is an MR in which a first UE is currently located, and the MR 3000 includes a processor 3001, a memory 3002, and a transmitting and receiving circuit 3003.

The transmitting and receiving circuit 3003 is configured to send a route request message to an H-LM of a second UE, where the route request message includes an IP address of the first UE and flag bit information, and the flag bit information is used to indicate that the MR 3000 is an H-MR of the first UE, and further receive a route rejection message sent by the H-LM of the second UE.

According to this embodiment of the present disclosure, for two UEs that are both currently located in home networks, flag bit information is added to identify whether the UEs are currently located in the home networks, and further determine whether a route optimization process needs to be performed.

Components in the MR 3000 are coupled together using a bus system 3004, where in addition to a data bus, the bus system 3004 includes a power supply bus, a control bus, and a status signal bus. However, for clarity of description, various buses are marked as the bus system 3004 in FIG. 30.

The foregoing methods disclosed in the embodiments of the present disclosure may be applied to the processor 3001, or implemented by the processor 3001. The processor 3001 may be an integrated circuit chip and has a signal processing capability. In an implementation process, the steps of the foregoing methods may be completed using an integrated logic circuit of hardware in the processor 3001 or an instruction in a form of software. The processor 3001 may be a general purpose processor, a DSP, an ASIC, an FPGA or another programmable logic device, a discrete gate or transistor logic device, or a discrete hardware assembly. The processor 3001 can implement or execute the methods, the steps, and the logical block diagrams disclosed in the embodiments of the present disclosure. The general purpose processor may be a microprocessor, or the processor may be any conventional processor or the like. The steps of the methods disclosed with reference to the embodiments of the present disclosure may be directly implemented by means of a hardware decoding processor, or may be implemented using a combination of hardware and software modules in the decoding processor. The software module may be located in a mature storage medium in the art, such as a RAM, a flash memory, a ROM, a programmable read-only memory, an electrically erasable programmable memory, or a register. The storage medium is located in the memory 3002, and the processor 3001 reads information in the memory 3002 and completes the steps of the foregoing methods in combination with hardware of the processor 3001.

The MR 3000 can implement each process implemented by the first MR in the embodiment in FIG. 14, and to avoid repetition, details are not repeated herein.

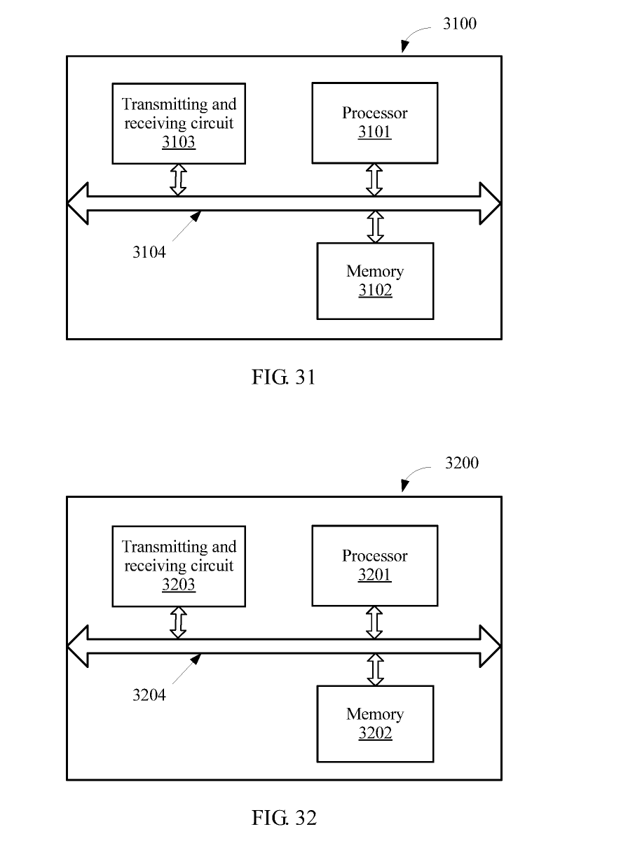

FIG. 31 is a block diagram of an LM according to another embodiment of the present disclosure. An LM 3100 shown in FIG. 31 is an H-LM of a second UE, and the LM 3100 includes a processor 3101, a memory 3102, and a transmitting and receiving circuit 3103.

The transmitting and receiving circuit 3103 is configured to receive a route request message sent by an MR in which first UE is currently located, where the route request message includes an IP address of the first UE and flag bit information, and the flag bit information is used to indicate that the MR is an H-MR of the first UE, and further send a route rejection message to the MR.

According to this embodiment of the present disclosure, for two UEs that are both currently located in home networks, flag bit information is added to identify whether the UEs are currently located in the home networks, and further determine whether a route optimization process needs to be performed.

Components in the LM 3100 are coupled together using a bus system 3104, where in addition to a data bus, the bus system 3104 includes a power supply bus, a control bus, and a status signal bus. However, for clarity of description, various buses are marked as the bus system 3104 in FIG. 31.

The foregoing methods disclosed in the embodiments of the present disclosure may be applied to the processor 3101, or implemented by the processor 3101. The processor 3101 may be an integrated circuit chip and has a signal processing capability. In an implementation process, the steps of the foregoing methods may be completed using an integrated logic circuit of hardware in the processor 3101 or an instruction in a form of software. The processor 3101 may be a general purpose processor, a DSP, an ASIC, an FPGA or another programmable logic device, a discrete gate or transistor logic device, or a discrete hardware assembly. The processor 3101 can implement or execute the methods, the steps, and the logical block diagrams disclosed in the embodiments of the present disclosure. The general purpose processor may be a microprocessor, or the processor may be any conventional processor or the like. The steps of the methods disclosed with reference to the embodiments of the present disclosure may be directly implemented by means of a hardware decoding processor, or may be implemented using a combination of hardware and software modules in the decoding processor. The software module may be located in a mature storage medium in the art, such as a RAM, a flash memory, a ROM, a programmable read-only memory, an electrically erasable programmable memory, or a register. The storage medium is located in the memory 3102, and the processor 3101 reads information in the memory 3102 and completes the steps of the foregoing methods in combination with hardware of the processor 3101.

The LM 3100 can implement each process implemented by the H-LM of the second UE in the embodiment in FIG. 15. To avoid repetition, details are not repeated herein.

FIG. 32 is a block diagram of an MR according to another embodiment of the present disclosure. An MR 3200 shown in FIG. 32 is an MR in which a first UE is currently located, and the MR 3200 includes a processor 3201, a memory 3202, and a transmitting and receiving circuit 3203.

The transmitting and receiving circuit 3203 is configured to send a route request message to an H-LM of a second UE, where the route request message includes an IP address of the first UE, and further receive a route response message sent by the H-LM of the second UE, where the route response message includes flag bit information, and the flag bit information is used to indicate that a second MR in which the second UE is currently located is an H-MR of the second UE, where the first UE is currently located in a home network.

In this way, according to this embodiment of the present disclosure, flag bit information used to indicate that a UE is located in a home network is added into a route optimization process in order to determine whether route optimization needs to be performed, thereby avoiding establishing a tunnel when two UEs are located in home networks and reducing expenditure.

Components in the MR 3200 are coupled together using a bus system 3204, where in addition to a data bus, the bus system 3204 includes a power supply bus, a control bus, and a status signal bus. However, for clarity of description, various buses are marked as the bus system 3204 in FIG. 32.

The foregoing methods disclosed in the embodiments of the present disclosure may be applied to the processor 3201, or implemented by the processor 3201. The processor 3201 may be an integrated circuit chip and has a signal processing capability. In an implementation process, the steps of the foregoing methods may be completed using an integrated logic circuit of hardware in the processor 3201 or an instruction in a form of software. The processor 3201 may be a general purpose processor, a DSP, an ASIC, an FPGA or another programmable logic device, a discrete gate or transistor logic device, or a discrete hardware assembly. The processor 3201 can implement or execute the methods, the steps, and the logical block diagrams disclosed in the embodiments of the present disclosure. The general purpose processor may be a microprocessor, or the processor may be any conventional processor or the like. The steps of the methods disclosed with reference to the embodiments of the present disclosure may be directly implemented by means of a hardware decoding processor, or may be implemented using a combination of hardware and software modules in the decoding processor. The software module may be located in a mature storage medium in the art, such as a RAM, a flash memory, a ROM, a programmable read-only memory, an electrically erasable programmable memory, or a register. The storage medium is located in the memory 3202, and the processor 3201 reads information in the memory 3202 and completes the steps of the foregoing methods in combination with hardware of the processor 3201.

The MR 3200 can implement each process implemented by the first MR in the embodiment in FIG. 17, and to avoid repetition, details are not repeated herein.

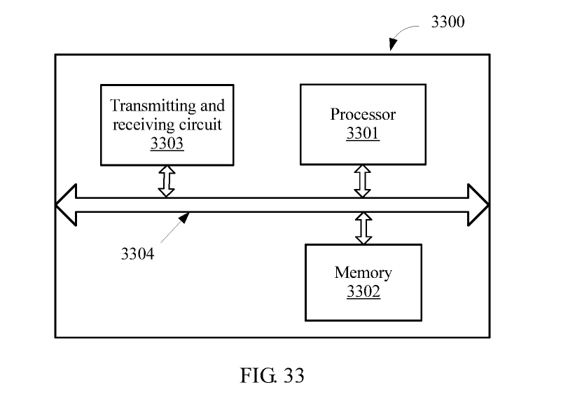

FIG. 33 is a block diagram of an LM according to another embodiment of the present disclosure. An LM 3300 shown in FIG. 33 is an H-LM of a second UE, and the LM 3300 includes a processor 3301, a memory 3302, and a transmitting and receiving circuit 3303.

The transmitting and receiving circuit 3303 is configured to receive a route request message sent by a first MR in which first UE is currently located, where the route request message includes an IP address of the first UE, and further send a route response message to the first MR, where the route response message includes flag bit information, and the flag bit information is used to indicate that a second MR in which the second UE is currently located is an H-MR of the second UE such that the first MR terminates a route optimization process, where the first UE is currently located in a home network.

In this way, according to this embodiment of the present disclosure, flag bit information used to indicate that UE is located in a home network is added into a route optimization process in order to determine whether route optimization needs to be performed, thereby avoiding establishing a tunnel when two UEs are located in home networks and reducing expenditure.

Components in the LM 3300 are coupled together using a bus system 3304, where in addition to a data bus, the bus system 3304 includes a power supply bus, a control bus, and a status signal bus. However, for clarity of description, various buses are marked as the bus system 3304 in FIG. 33.

The foregoing methods disclosed in the embodiments of the present disclosure may be applied to the processor 3301, or implemented by the processor 3301. The processor 3301 may be an integrated circuit chip and has a signal processing capability. In an implementation process, the steps of the foregoing methods may be completed using an integrated logic circuit of hardware in the processor 3301 or an instruction in a form of software. The processor 3301 may be a general purpose processor, a DSP, an ASIC, an FPGA or another programmable logic device, a discrete gate or transistor logic device, or a discrete hardware assembly. The processor 3301 can implement or execute the methods, the steps, and the logical block diagrams disclosed in the embodiments of the present disclosure. The general purpose processor may be a microprocessor, or the processor may be any conventional processor or the like. The steps of the methods disclosed with reference to the embodiments of the present disclosure may be directly implemented by means of a hardware decoding processor, or may be implemented using a combination of hardware and software modules in the decoding processor. The software module may be located in a mature storage medium in the art, such as a RAM, a flash memory, a ROM, a programmable read-only memory, an electrically erasable programmable memory, or a register. The storage medium is located in the memory 3302, and the processor 3301 reads information in the memory 3302 and completes the steps of the foregoing methods in combination with hardware of the processor 3301.

The LM 3300 can implement each process implemented by the H-LM of the second UE in the embodiment in FIG. 18, and to avoid repetition, details are not repeated herein.

A person of ordinary skill in the art may be aware that, in combination with the examples described in the embodiments disclosed in this specification, units and methods may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

In the embodiments provided in the present application, it should be understood that the disclosed apparatus and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present disclosure essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of the present disclosure. The foregoing storage medium includes any medium that can store program code, such as a universal serial bus (USB) flash drive, a removable hard disk, a ROM, a RAM, a magnetic disk, or an optical disc.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A route optimization method, comprising:
establishing a forwarding tunnel between a first mobile router (MR) in a first network in which a first user equipment (UE) is currently located and a second MR in a second network in which a second UE is currently located, wherein at least one UE of the first UE and the second UE is currently located in a visited network; and
transmitting data between the first UE and the second UE over the forwarding tunnel.

2. The method according to claim 1, wherein establishing the forwarding tunnel between the first MR in the first network in which the first UE is currently located and the second MR in the second network in which the second UE is currently located comprises:
sending, by the first MR, a first route request message to a home location manager entity (H-LM) of the second UE, wherein the first route request message comprises an Internet Protocol (IP) address of the second UE;
receiving, by the first MR, a first route response message sent by the H-LM of the second UE, wherein the first route response message comprises an address of the second MR; and
establishing, by the first MR, the forwarding tunnel between the first MR and the second MR according to the address of the second MR.

3. The method according to claim 2, wherein before sending, by the first MR, the first route request message to the H-LM entity of the second UE, the method further comprises:
receiving, by the first MR, a packet sent by the first UE;
acquiring, by the first MR, the IP address of the second UE in the packet;
buffering, by the first MR, the packet, and
wherein after establishing, by the first MR, the forwarding tunnel between the first MR and the second MR according to the address of the second MR, the method further comprises transmitting, by the first MR, the packet to the second MR over the forwarding tunnel.

4. The method according to claim 2, wherein when the first UE is currently located in a home network, the first route request message further comprises first flag bit information, and wherein the first flag bit information is used to indicate that the first MR is a home mobile router (H-MR) of the first UE.

5. The method according to claim 2, wherein when the second UE is currently located in a home network, the first route response message further comprises second flag bit information, and wherein the second flag bit information is used to indicate that the second MR is a home mobile router (H-MR) of the second UE.

6. The method according to claim 2, wherein establishing, by the first MR, a forwarding tunnel between the first MR and the second MR according to the address of the second MR comprises:
sending, by the first MR, a first tunnel establishment request message to the second MR; and
receiving, by the first MR, a first tunnel establishment response message sent by the second MR in order to complete establishing of the forwarding tunnel.

7. The method according to claim 2, wherein establishing, by the first MR, the forwarding tunnel between the first MR and the second MR according to the address of the second MR comprises:
receiving, by the first MR, a second tunnel establishment request message sent by the second MR; and
sending, by the first MR, a second tunnel establishment response message to the second MR in order to complete establishing of the forwarding tunnel.

8. The method according to claim 2, wherein after establishing, by the first MR, the forwarding tunnel between the first MR and the second MR according to the address of the second MR, the method further comprises binding, by the first MR, the following information:
an IP address of the first UE;
the IP address of the second UE;
the address of the second MR; and
tunnel information of the forwarding tunnel.

9. A mobile router (MR), wherein the MR is an MR in which a first user equipment (UE) is currently located, and wherein the MR comprises:
a transmitter configured to send a route request message to a home location manager entity (H-LM) of a second UE, wherein the route request message comprises an Internet Protocol (IP) address of the second UE;
a receiver configured to receive a route response message sent by the H-LM of the second UE, wherein the route response message comprises an address of a second MR in which the second UE is currently located; and
a processor coupled to the transmitter, and the receiver is configured to establish a forwarding tunnel between the MR and the second MR according to the address of the second MR, wherein at least one UE of the first UE and the second UE is currently located in a visited network.

10. The MR according to claim 9, wherein the receiver is further configured to receive a packet sent by the first UE, wherein the processor is further configured to:
acquire the IP address of the second UE in the packet received by the receiver;
buffer the packet received by the receiver, and
wherein the transmitter is further configured to transmit, to the second MR over the forwarding tunnel established by the processor, the packet buffered by the processor.

11. The MR according to claim 9, wherein when the first UE is currently located in a home network, the route request message further comprises first flag bit information, and wherein the first flag bit information is used to indicate that the MR is a home mobile router (H-MR) of the first UE.

12. The MR according to claim 9, wherein when the second UE is currently located in a home network, the route response message further comprises second flag bit information, and wherein the second flag bit information is used to indicate that the second MR is a home mobile router (H-MR) of the second UE.

13. The MR according to claim 9, wherein the transmitter is further configured to send a first tunnel establishment request message to the second MR, and wherein the receiver is further configured to receive a first tunnel establishment response message sent by the second MR in order to complete establishing of the forwarding tunnel.

14. The MR according to claim 9, wherein the receiver is further configured to receive a second tunnel establishment request message sent by the second MR, and wherein the transmitter is further configured to send a second tunnel establishment response message to the second MR in order to complete establishing of the forwarding tunnel.

15. The MR according to claim 9, wherein the processor is further configured to bind the following information:
an IP address of the first UE;
the IP address of the second UE;
the address of the second MR; and
tunnel information of the forwarding tunnel.

16. The MR according to claim 15, wherein the processor is further configured to unbind the information when the first UE is currently located in the visited network and the first UE is not currently located within a service range of the MR any longer, and when the second UE is currently located in the visited network and the second UE is not currently located within a service range of the second MR any longer.

17. The MR according to claim 9, wherein the processor is further configured to release the forwarding tunnel when the forwarding tunnel is not shared by another UE.

18. A location manager entity (LM), wherein the LM is a home location manager entity (H-LM) of a first user equipment (UE), and wherein the LM comprises:
a receiver configured to receive a route request message sent by a second mobile router (MR) in which a second UE is currently located, wherein the route request message comprises an Internet Protocol (IP) address of the first UE; and
a transmitter coupled to the receiver and configured to send a route response message to the second MR, wherein the route response message comprises an address of a first MR in which the first UE is currently located, wherein at least one UE of the first UE and the second UE is currently located in a visited network.

19. The LM according to claim 18, wherein when the second UE is currently located in a home network, the route request message further comprises first flag bit information, and wherein the first flag bit information is used to indicate that the second MR is a home mobile router (H-MR) of the second UE.

20. The LM according to claim 18, wherein when the first UE is currently located in a home network, wherein the route response message further comprises second flag bit information, and wherein the second flag bit information is used to indicate that the first MR is a home mobile router (H-MR) of the first UE.
